(19) United States
(12) Patent Application Publication
(10) Pub. No.: US 2024/0281096 A1
(43) Pub. Date: Aug. 22, 2024

(54) TOUCH SCREEN

(71) Applicant: ALPS ALPINE CO., LTD., Tokyo (JP)

(72) Inventors: Masahiro TAKATA, Miyagi (JP); Akihiro WATARI, Tokyo (JP); Yasuji HAGIWARA, Miyagi (JP); Keitaro UCHIDA, Miyagi (JP)

(21) Appl. No.: 18/639,548

(22) Filed: Apr. 18, 2024

Related U.S. Application Data
(63) Continuation of application No. PCT/JP2022/038154, filed on Oct. 13, 2022.

(30) Foreign Application Priority Data
Nov. 2, 2021 (JP) 2021-179665

(51) Int. Cl. G06F 3/044; G06F 3/0481

(52) U.S. Cl. CPC G06F 3/044; G06F 3/0481

(57) ABSTRACT

A touch screen includes sensor electrodes to detect an object in proximity in accordance with a capacitance; a display device at a position overlapping the sensor electrodes; a detector connected to the sensor electrodes and configured to detect the capacitance between the sensor electrodes and the object; and a controller to control an image displayed by the display device based on an output from the detector and determine an input content input by the object. The controller is configured to cause the display device to display: a GUI button image representing an input operation area; and an input content display image representing the input content input by an operation performed on the GUI button. Upon the capacitance detected by the detector being a first threshold or more, the controller is configured to move the input content display image to a position not overlapping the sensor electrode that detects maximum capacitance.

### CROSS-REFERENCE TO RELATED APPLICATIONS

This application is a continuation application of International Application No. PCT/JP2022/038154, filed on Oct. 13, 2022, and designated the U.S., which is based upon and claims priority to Japanese Patent Application No. 2021-179665, filed on Nov. 2, 2021, the entire contents of which are incorporated herein by reference.

### BACKGROUND

### 1. Field of the Invention

The present disclosure relates to touch screens.

### 2. Description of the Related Art

Portable information terminal devices capable of inputting characters by handwriting are known. In the portable information terminal devices, the characters are handwritten in a character input area displayed on a screen. When the character input area is displayed on the screen, some of the portable information terminal devices determine an area not overlapping an editing area, and display the character input area at a predetermined position in the determined area (see, for example, Japanese Patent Publication No. 2003-067673 and U.S. Pat. No. 8,271,900 B2).

### SUMMARY

A touch screen according to an embodiment of the present disclosure includes: a plurality of sensor electrodes configured to detect an object in proximity to the sensor electrodes in accordance with a capacitance; a display device provided at a position overlapping the plurality of sensor electrodes; a detector connected to the plurality of sensor electrodes and configured to detect the capacitance between the plurality of sensor electrodes and the object; and a controller configured to control an image displayed by the display device based on an output from the detector and determine an input content that is input by the object. The controller is configured to cause the display device to display: an image of a graphic user interface (GUI) button representing an input operation area; and an image of an input content display representing the input content that is input by an operation performed on the GUI button. Upon the capacitance detected by the detector being equal to or greater than a first threshold, the controller is configured to move the image of the input content display to a position not overlapping the sensor electrode of the plurality of sensor electrodes that detects a maximum capacitance.

### BRIEF DESCRIPTION OF THE DRAWINGS

FIG. 1 is a perspective diagram of an external appearance of a touch screen 100 of Embodiment 1;

FIG. 2 is a diagram illustrating an example of a configuration of a position input device 130;

FIG. 3 is a diagram illustrating a capacitance formed in the position input device 130;

FIG. 4A is an explanatory diagram of display by a display device 120 of Embodiment 1;

FIG. 4B is an explanatory diagram of display by the display device 120 of Embodiment 1;

FIG. 4C is an explanatory diagram of display by the display device 120 of Embodiment 1;

FIG. 4D is an explanatory diagram of display by the display device 120 of Embodiment 1;

FIG. 4E is an explanatory diagram of display by the display device 120 of Embodiment 1;

FIG. 4F is an explanatory diagram of display by the display device 120 of Embodiment 1;

FIG. 4G is an explanatory diagram of display by the display device 120 of Embodiment 1;

FIG. 5 is a diagram illustrating an internal configuration of the touch screen 100;

FIG. 6 is a diagram illustrating a hardware configuration of a control device 140;

FIG. 7 is a diagram illustrating a functional configuration of the control device 140;

FIG. 8 is a flowchart illustrating a process executed by the control device 140 of Embodiment 1;

FIG. 9 is a flowchart illustrating a process executed by the control device 140 of Embodiment 1;

FIG. 10A is an explanatory diagram of display by a display device 120M of Embodiment 2;

FIG. 10B is an explanatory diagram of display by the display device 120M of Embodiment 2;

FIG. 10C is an explanatory diagram of display by the display device 120M of Embodiment 2;

FIG. 10D is an explanatory diagram of display by the display device 120M of Embodiment 2;

FIG. 10E is an explanatory diagram of display by the display device 120M of Embodiment 2;

FIG. 10F is an explanatory diagram of display by the display device 120M of Embodiment 2;

FIG. 10G is an explanatory diagram of display by the display device 120M of Embodiment 2;

FIG. 10H is an explanatory diagram of display by the display device 120M of Embodiment 2;

FIG. 11 is a flowchart illustrating a process executed by the control device 140 of Embodiment 2;

FIG. 12 is a flowchart illustrating the process executed by the control device 140 of Embodiment 2; and

FIG. 13 is a flowchart illustrating the process executed by the control device 140 of Embodiment 2.

### DESCRIPTION OF THE EMBODIMENTS

Existing portable information terminal devices require a screen having a size larger than the size necessary for inputting characters, in order to display a character input area for inputting characters by handwriting using a pen or the like so as not to overlap an area that is being edited.

It is an object of the present disclosure to provide a touch screen configured to move an image of an input content display representing an input content that is input by an operation with a hand or the like so as not to overlap the hand or the like, even if a large area of the screen is formed of GUI buttons.

Hereinafter, embodiments in which the touch screen of the present disclosure is applied will be described.

### Embodiment 1

### <Touch Screen 100>

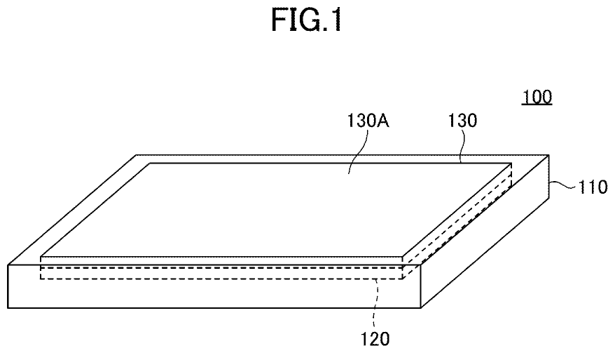

FIG. 1 is a perspective diagram of the external appearance of the touch screen 100 of Embodiment 1. The touch screen 100 as illustrated in FIG. 1 can be operated by touch input and hover input. The touch input is an input method performed by contacting (touching) an operation surface 130A of the touch screen 100 with a finger, a hand, or the like. The hover input is an input method performed in a non-contact state by making a finger, a hand, or the like in proximity to the operation surface 130A (in a state in which a finger, a hand, or the like remains floating over the operation surface 130A). The finger or hand of a user is an example of a thing used for operation, and is an example of the object in proximity to the operation surface 130A. The following description will be made when a user operates the operation surface 130A with his or her fingertip. However, the user can operate the operation surface 130A with a part of the finger other than the fingertip, a part of the hand other than the finger, or a part of the body other than the hand.

The touch screen 100 receives an input by movement of the user's fingertip, and controls the operation of a control target device in accordance with operation contents. The touch screen 100 may remotely operate the control target device or may be provided integrally with the control target device. The touch screen 100 may be portable or may be fixed to a wall surface or the like. Here, as an example, description will be given of a form in which the touch screen 100 delivers data representing contents determined to be input, to an application program of the control target device.

As illustrated in FIG. 1, the touch screen 100 includes a housing 110, the display device 120, and the position input device 130.

The housing 110 is a box-shaped member configured to house and retain various components. The display device 120 and the position input device 130 are retained in the housing 110. The position input device 130 is disposed on the display device 120. In the example as illustrated in FIG. 1, the housing 110 has a rectangular parallelepiped shape. However, the housing 110 may have a shape other than the rectangular parallelepiped shape. For example, the touch screen 100 may be free of the housing 110 and may be disposed so as to be embedded in a predetermined place.

The display device 120 is a flat and thin device. The display device 120 is superimposed on the lower surface of the position input device 130. The display device 120 is, for example, a liquid crystal display, an organic EL display, or the like. The display device 120 displays various display contents. The display device 120 can display a plurality of GUI operation buttons side by side. The GUI button is an image of a push button displayed on the display device 120 through a GUI. The display contents displayed on the display device 120 are visually recognizable by the user from above the touch screen 100 through the position input device 130.

The position input device 130 is a flat and thin device. The position input device 130 is provided on the upper surface of the housing 110. The position input device 130 includes the operation surface 130A. The operation surface 130A is a top plate surface located at the uppermost surface of the position input device 130, and is exposed from the top surface of the housing 110. The position input device 130 is configured such that both the touch input (contact input) and the hover input (non-contact input) can be performed on the operation surface 130A by the user's fingertip. A capacitive position input device is used as the position input device 130.

### <Example of the Configuration of the Position Input Device 130>

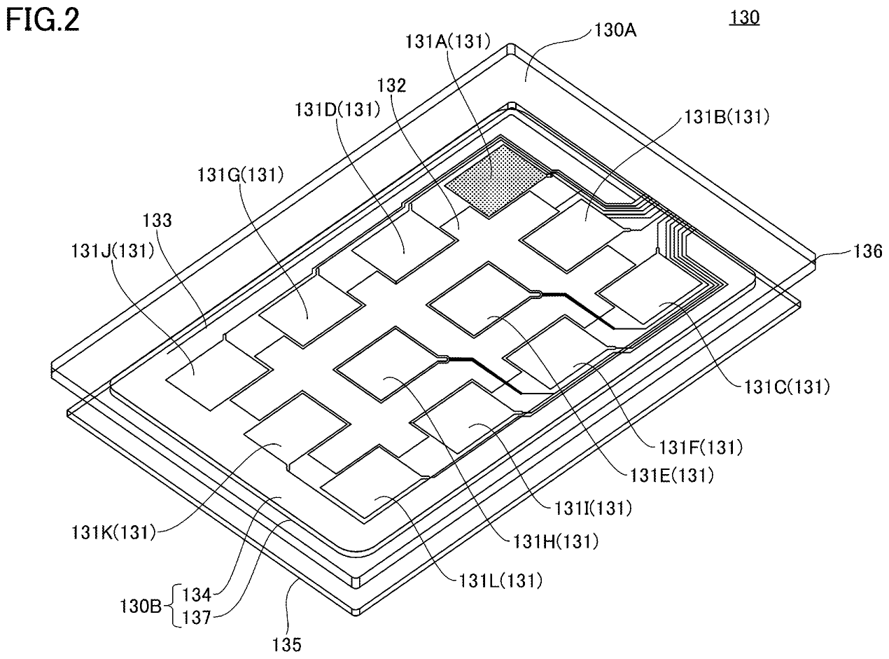

FIG. 2 is a diagram illustrating an example of the configuration of the position input device 130. As illustrated in FIG. 2, the position input device 130 includes a top plate 136, a sensor portion 130B, and a substrate 135 in the order from above in the drawing (from the operation surface 130A side).

The top plate 136 is a transparent and thin plate member that is provided on the uppermost layer (upper side of the sensor portion 130B) of the position input device 130. That is, the upper surface of the top plate 136 becomes the operation surface 130A of the position input device 130. The top plate 136 is an example of a cover that can be contacted by a user with his or her fingertip or the like. The top plate 136 is formed by attaching a decorative film having light transparency to the surface of a thin glass plate. The decorative film shows a specific surface pattern (e.g., grain pattern, metallic pattern, or the like) on the front surface of the position input device 130 when the display device 120 provided on the rear surface of the position input device 130 is not displayed. The decorative film may not be provided. Further, a transparent plate may be provided on the top plate 136. In this case, the transparent plate provided on the top plate 136 is an example of the cover, and the upper surface of the plate becomes the operation surface.

The sensor portion 130B is provided between the top plate 136 and the substrate 135. The sensor portion 130B is formed by superimposing a sensor film 134 (polyethylene terephthalate (PET) film) on the top surface of the glass plate 137. The sensor film 134 is provided with sensor electrodes 131A to 131L, an approach detection electrode 132, and a noise detection electrode 133. The sensor electrodes 131A to 131L, the approach detection electrode 132, and the noise detection electrode 133 are each formed of a conductive thin film material (e.g., a copper foil, a conductive polymer, or the like). When the sensor electrodes 131A to 131L are not distinguished from each other, the sensor electrodes 131A to 131L are simply referred to as the sensor electrode 131. Also, the approach detection electrode 132 and the noise detection electrode 133 may not be provided.

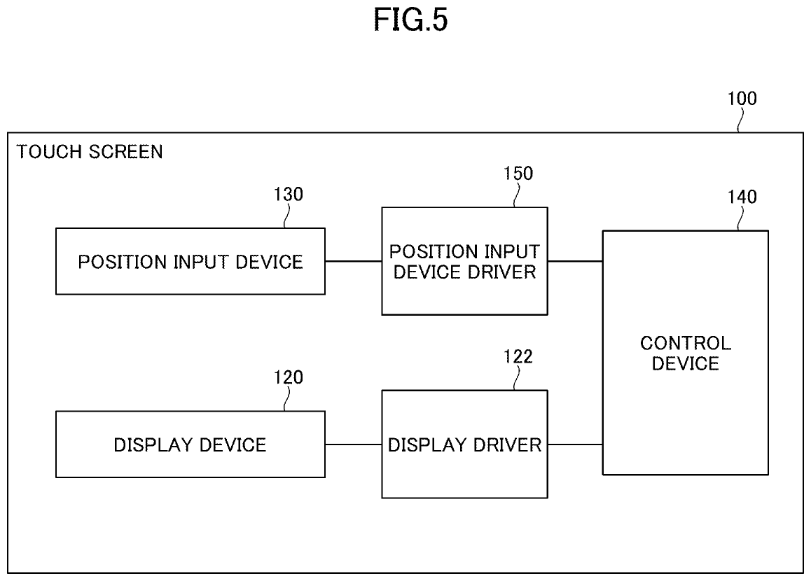

An active shield electrode AS is provided on the lower surface of a glass plate 137. The active shield electrode AS is driven by a position input device driver 150 (see FIG. 5) to inhibit the outflow of a current to the ground from the sensor electrodes 131A to 131L and the approach detection electrode 132. Thereby, the active shield electrode AS increases the capacitance detectable by the sensor electrodes 131A to 131L and the approach detection electrode 132.

The sensor electrodes 131A to 131L are provided corresponding to the plurality of GUI buttons. In the example as illustrated in FIG. 2, the sensor electrodes 131A to 131L are arranged in 4 rows×3 columns corresponding to the plurality of GUI buttons to be displayed on the display device 120. Each of the sensor electrodes 131A to 131L is provided to detect the touch input and the hover input performed on the corresponding GUI button based on a change in capacitance. A range detectable by the sensor electrodes 131A to 131L is, for example, within a distance of about 3 cm or more and about 5 cm or less from the operation surface 130A. The sensor electrodes 131A to 131L can detect that the fingertip is in proximity to the operation surface 130A within the distance of about 3 cm or more and about 5 cm or less from the operation surface 130A. The state in which the fingertip is in proximity to the operation surface 130A includes a state in which the below-described proximate operation is performed and a state in which the hover input or the touch input is performed.

The approach detection electrode 132 has a shape that fills spaces between the sensor electrodes 131A to 131L over a relatively wide area of the sensor film 134. The approach detection electrode 132 is provided to detect the approach of the fingertip to the operation surface 130A based on a change in capacitance. The range in which the fingertip is detectable by the approach detection electrode 132 is, for example, within about 10 cm from the operation surface 130A. Here, what is meant by the approach is a state in which the fingertip is located at a position away from the proximate range in which the fingertip is detectable by the sensor electrodes 131A to 131L, in the range in which the fingertip is detectable by the approach detection electrode 132. Therefore, for example, when the range in which the fingertip is detectable by the sensor electrodes 131A to 131L is within about 5 cm from the operation surface 130A, the approach means, for example, that the fingertip is located away by about 5 cm from the operation surface 130A and within about 10 cm from the operation surface 130A.

When the maximum value of the capacitances detected by the sensor electrodes 131A to 131L becomes equal to or greater than the first threshold, the control device 140 determines that a proximate operation is performed by making the fingertip in proximity to the operation surface 130A. The proximate operation is an operation for selecting one of the GUI buttons, and is performed in a state in which the fingertip does not sufficiently come close to the operation surface 130A for enabling the hover input. When the maximum value of the capacitances detected by the sensor electrodes 131A to 131L becomes equal to or greater than the first threshold, the control device 140 can identify the GUI button selected by the proximate operation.

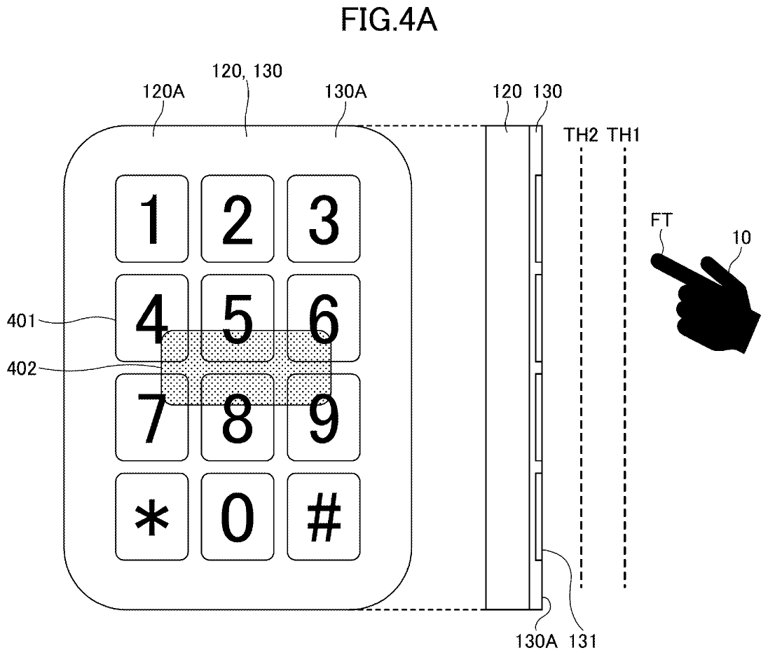

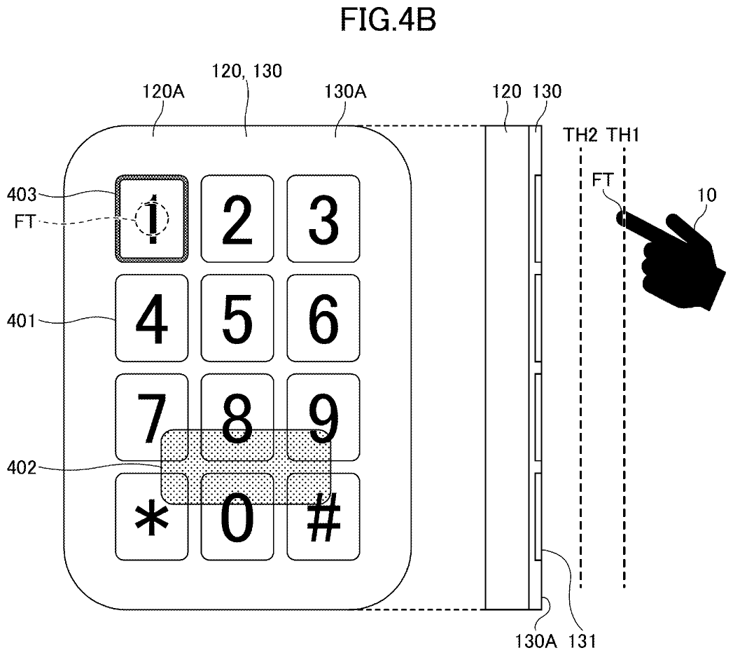

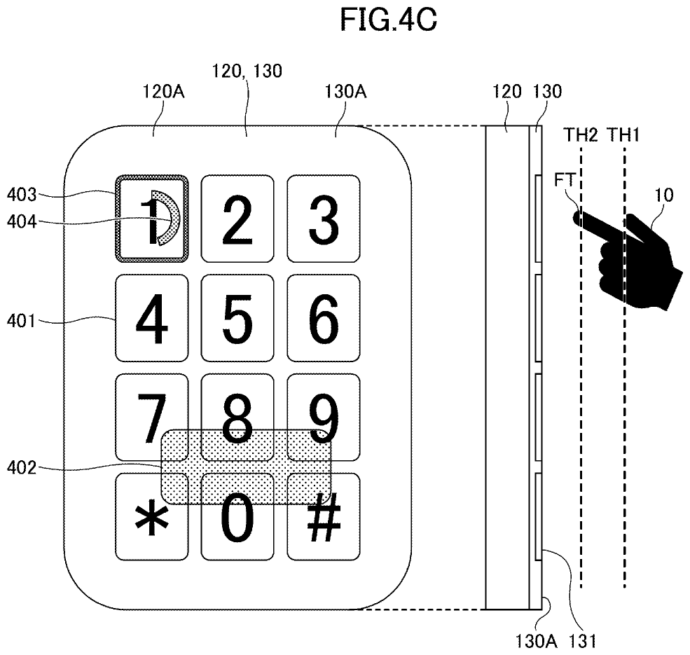

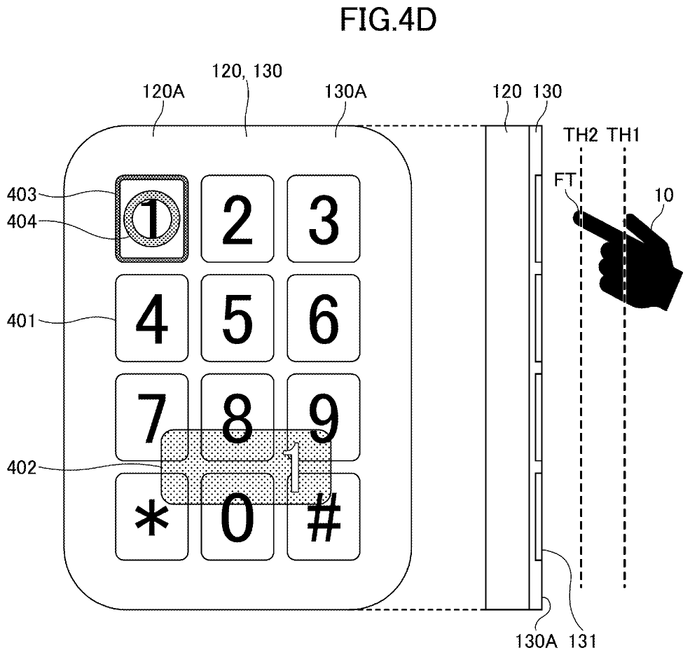

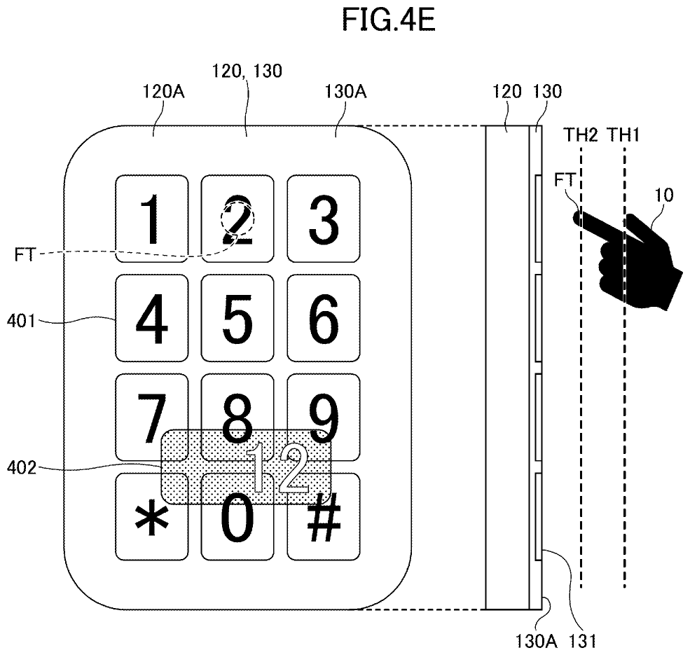

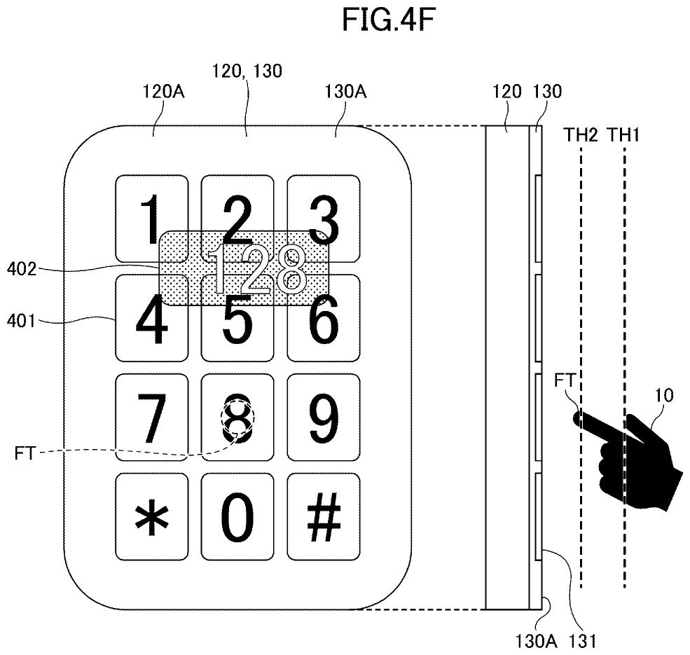

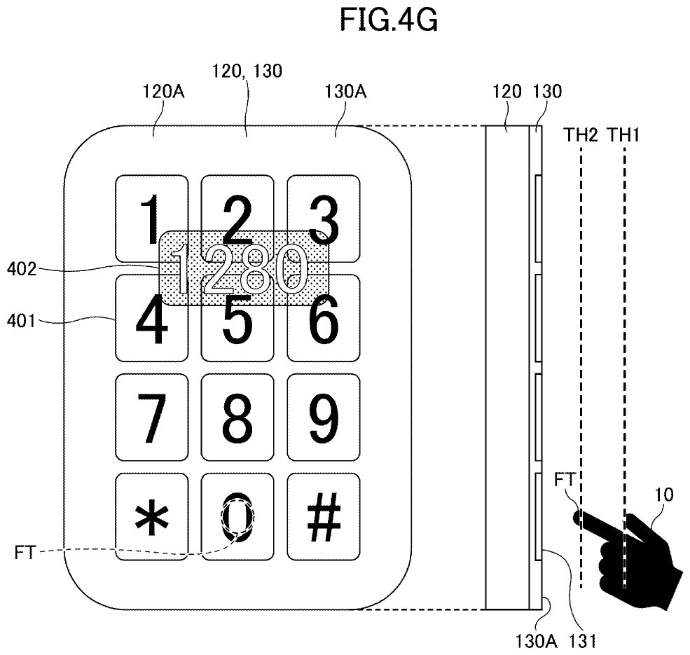

When the maximum value of the capacitances detected by the sensor electrodes 131A to 131L becomes equal to or greater than a second threshold that is greater than the first threshold, the control device 140 determines that the hover input is performed. The second threshold corresponds to the capacitance at which the input is determinable in a state in which the fingertip is not in contact with the top plate 136. In addition, when the touch input is performed, the maximum value of the capacitances detected by the sensor electrodes 131A to 131L is equal to or greater than the second threshold, and a capacitance greater than the capacitance detected when the non-contact hover input is performed on the operation surface 130A is detected. However, the control device 140 may or may not make a distinction between the touch input and the hover input. When making a distinction between the touch input and the hover input, a third threshold greater than the second threshold may be used to determine the touch input. The first threshold and the second threshold will be described below with reference to FIG. 4A to FIG. 4G.

The noise detection electrode 133 is a thin and long band-shaped electrode extending along the outer periphery of the sensor film 134. The noise detection electrode 133 is provided for detecting noise that enters the position input device 130.

The substrate 135 is a thin plate member provided on the lowermost layer of the position input device 130 (lower surface of the sensor portion 130B). The sensor portion 130B is formed on the upper surface of the substrate 135. As the substrate 135, for example, a glass substrate or a transparent resin substrate is used.

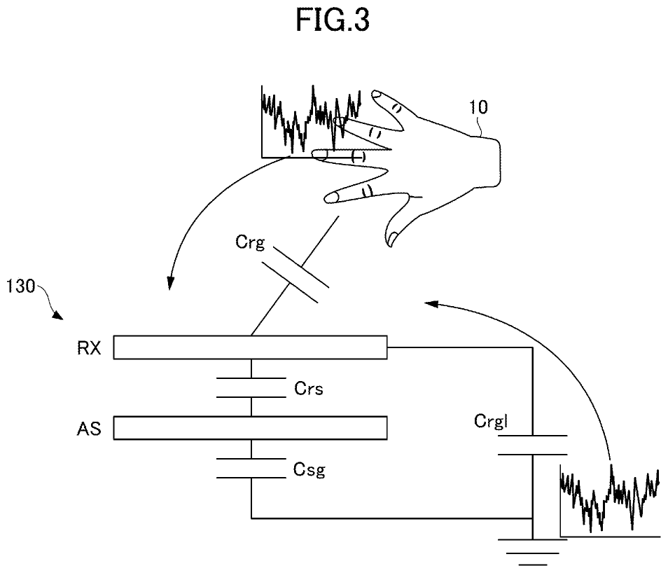

FIG. 3 is a diagram illustrating a capacitance formed in the position input device 130. FIG. 3 illustrates a hand 10 rather than the fingertip.

As illustrated in FIG. 3, in the position input device 130, a capacitance Crg is formed between a detection electrode RX (i.e., the sensor electrodes 131A to 131L, the approach detection electrode 132, and the noise detection electrode 133) and the hand 10.

In the position input device 130, a capacitance Crs is formed between the detection electrode RX and the active shield electrode AS.

In the position input device 130, a capacitance Csg is formed between the active shield electrode AS and the ground.

In the position input device 130, a parasitic capacitance Crgl is formed between the detection electrode RX and the ground.

By detecting the capacitance Crg formed between the detection electrode RX and the hand 10, the position input device 130 can detect the approach of the hand 10 to the operation surface 130A, the hover input, and the touch input.

The position, width, and length of the noise detection electrode 133 in the position input device 130 are designed such that the sum of Crg of the approach detection electrode 132 and Crgl of the approach detection electrode 132 is equal to the sum of Crg of the noise detection electrode 133 and Crgl of the noise detection electrode 133. Thereby, the position input device 130 is designed such that the approach detection electrode 132 and the noise detection electrode 133 receive noise having the same phase and the same quantity. Therefore, the position input device 130 can remove noise with higher accuracy by subtracting the output from the noise detection electrode 133 from the quantity of change in the approach detection electrode 132.

### <Display by the Display Device 120>

FIG. 4A to FIG. 4G are explanatory diagrams of display by the display device 120 of Embodiment 1. The left-hand side of FIG. 4A to FIG. 4G illustrates a state in which the display device 120, a display area 120A, the position input device 130, and the operation surface 130A are viewed from the upper side thereof. The right-hand side of FIG. 4A to FIG. 4G illustrates cross sections of the display device 120, the display area 120A, the position input device 130, and the operation surface 130A as viewed from the left-hand side thereof. The sensor electrode 131, a first threshold TH1, a second threshold TH2, and the hand 10 are additionally illustrated in the cross section. The size of the display area 120A and the size of the operation surface 130A are approximately the same, and for example, the operation surface 130A overlaps the entirety of the display area 120A.

The left-hand side of FIG. 4A to FIG. 4G illustrates a state in which GUI buttons 401 for inputting of numbers and an input content display 402 are displayed in the display area 120A. The right-hand side of FIG. 4A to FIG. 4G illustrates the position of a fingertip FT of the hand 10 with respect to the operation surface 130A. The first threshold TH1 and the second threshold TH2 are thresholds used by the control device 140 in determining the position of the fingertip FT with respect to the operation surface 130A based on the capacitance of the sensor electrode 131. In FIG. 4A to FIG. 4G, in order that the first threshold TH1 and the second threshold TH2 can be visually recognized, the first threshold TH1 and the second threshold TH2 are illustrated at positions distant from the operation surface 130A correspondingly to the capacitances of the first threshold TH1 and the second threshold TH2. Because the second threshold TH2 represents a capacitance larger than that of the first threshold TH1, a dashed line corresponding to the second threshold TH2 is closer to the operation surface 130A than is a dashed line corresponding to the first threshold TH1.

The first threshold TH1 is used to determine whether or not the proximate operation is performed on the operation surface 130A. The second threshold TH2 is used to determine whether or not the hover input is performed on the operation surface 130A.

### <GUI Button 401>

The number of the GUI buttons 401 for inputting of numbers is 12, i.e., numbers 0 to 9 and symbols * and #, which are arranged longitudinally and laterally in 4 rows (longitudinal)×3 columns (lateral) and displayed in the arrangement of a numeric keypad. Here, regarding the 12 GUI buttons 401 displayed in the display area 120A of the display device 120, the first row includes three GUI buttons 401 that display numbers 1, 2, and 3, and the second row includes three GUI buttons 401 that display numbers 4, 5, and 6. The third row includes three GUI buttons 401 that display numbers 7, 8, and 9, and the fourth row includes three GUI buttons 401 that display *, 0, and #. In this manner, the 12 GUI buttons 401 are displayed in four rows in a longitudinal direction.

Regarding the 12 GUI buttons 401, the first column includes four GUI buttons 401 that display numbers 1, 4, and 7, and symbol *, the second column includes four GUI buttons 401 that display numbers 2, 5, 8, and 0, and the third column includes four GUI buttons 401 that display numbers 3, 6, and 9, and symbol #.

In the following, in the display of the display area 120A of the display device 120, an upward-downward direction refers to a direction in which the first row to the fourth row are aligned (direction in which numbers 1, 4, and 7, and * are aligned) and a lateral direction refers to a direction in which each of the rows extends (direction in which numbers 1, 2, and 3 are aligned). The upward-downward direction is synonymous with the longitudinal direction. An upper half of the display area 120A refers to a half of the entirety of the display area 120A in which the GUI buttons 401 in the first row and the second row are displayed, and a lower half of the display area 120A refers to a half of the entirety of the display area 120A in which the GUI buttons 401 in the third row and the fourth row are displayed. The center of the display area 120A is a center between the GUI button 401 that displays number 5 in the second row and the GUI button 401 that displays number 8 in the third row.

For example, the arrangement of the 12 GUI buttons 401 corresponds to the arrangement of the 12 sensor electrodes 131 (131A to 131L) as illustrated in FIG. 2. For example, the size of each of the GUI buttons 401 is equal to the size of each of the sensor electrodes 131, and the GUI buttons 401 are displayed in the display area 120A such that the outer peripheries of the 12 GUI buttons 401 coincide with the outer peripheries of the 12 sensor electrodes 131 (131A to 131L).

Here, the size of each of the GUI buttons 401 being equal to the size of each of the sensor electrodes 131 means that lengths thereof in the longitudinal direction and the lateral direction only need to be equal even if areas thereof are not exactly the same. For example, when the GUI button 401 has rounded corners and the sensor electrode 131 does not have rounded corners, the area of the GUI button 401 and the area of the sensor electrode 131 are slightly different, but the lengths thereof in the longitudinal direction and the lateral direction are equal. Therefore, the sizes thereof are equal.

Further, the outer peripheries of the 12 GUI buttons 401 coinciding with the outer peripheries of the 12 sensor electrodes 131 (131A to 131L) is not limited to the case in which the outer peripheries of the 12 GUI buttons 401 exactly coincide with the outer peripheries of the 12 sensor electrodes 131 (131A to 131L). For example, the outer peripheries of the GUI button 401 with rounded corners do not coincide with the sensor electrodes 131 without rounded corners, but the positions of the four sides other than the four corners coincide with each other, and thus the outer peripheries of the 12 GUI buttons 401 coincide with the outer peripheries of the 12 sensor electrodes 131 (131A to 131L).

### <First Threshold TH1 and Second Threshold TH2>

Next, the first threshold TH1 and the second threshold TH2 will be described. In the following, a dashed-line vertical position from the operation surface 130A corresponding to the first threshold TH1 will be referred to as a position of the first threshold TH1, and a dashed-line vertical position from the operation surface 130A corresponding to the second threshold TH2 will be referred to as a position of the second threshold TH2.

When the fingertip FT is farther from the operation surface 130A than the position of the first threshold TH1, the capacitance of all of the sensor electrodes 131 is less than the first threshold TH1. When the fingertip FT is positioned directly above any one of the sensor electrodes 131 to operate the corresponding GUI button 401 and reaches the position of the first threshold TH1, the capacitance of the sensor electrode 131 becomes equal to the first threshold TH1. Also, when the fingertip FT is positioned directly above any one of the sensor electrodes 131 to operate the corresponding GUI button 401 and is closer to the operation surface 130A than is the position of the first threshold TH1, the capacitance of the sensor electrode 131 becomes greater than the first threshold TH1. The position of the first threshold TH1 is, for example, about 3 cm from the operation surface 130A.

The same applies to the second threshold. When the fingertip FT is farther from the operation surface 130A than the position of the second threshold TH2, the capacitance of all of the sensor electrodes 131 is less than the second threshold TH2. When the fingertip FT is positioned directly above any one of the sensor electrodes 131 to operate the corresponding GUI button 401 and reaches the position of the second threshold TH2, the capacitance of the sensor electrode 131 becomes equal to the second threshold TH2. When the fingertip FT is positioned directly above any one of the sensor electrodes 131 to operate the corresponding GUI button 401 and is closer to the operation surface 130A than is the position of the second threshold TH2, the capacitance of the sensor electrode 131 becomes greater than the second threshold TH2. The position of the second threshold TH2 is, for example, about 1 cm from the operation surface 130A.

### <Input Content Display 402>

The input content display 402 is a display configured to display an input content determined to be input by the touch input or the hover input performed on the GUI button 401. The input content display 402 is transparently displayed over the upper side (front side) of the image of the GUI button 401. The size of the input content display 402 is, for example, such that a longitudinal size is shorter than that of the GUI button 401 and a lateral size is slightly longer than that of the two GUI buttons 401.

### <Description of Operation as Illustrated in FIG. 4A to FIG. 4G>

As illustrated in FIG. 4A, in the initial state in which the fingertip FT does not reach the position of the first threshold TH1, the input content display 402 is displayed at a position including a space between the three GUI buttons 401 in the second row and the three GUI buttons 401 in the third row. The position between the second row and the third row is the position of the center of the display area 120A.

As illustrated in FIG. 4B, when the fingertip FT reaches the position of the first threshold TH1 directly above the GUI button 401 displaying number 1 in the first row, the proximate operation is recognized to be performed, and the input content display 402 is moved to a position including a space between the three GUI buttons 401 in the third row and the three GUI buttons 401 in the fourth row. In FIG. 4B, the position of the fingertip FT is illustrated by an oval dashed line in the GUI button 401 displaying number 1. The position including the space between the three GUI buttons 401 in the third row and the three GUI buttons 401 in the fourth row is a position including a space between two rows that are next to each other below the center in the longitudinal direction. The position including the space between the three GUI buttons 401 in the first row and the three GUI buttons 401 in the second row is a position including a space between two rows that are next to each other above the center in the longitudinal direction.

The fingertip FT reaching the position of the first threshold TH1 directly above the GUI button 401 displaying number 1 corresponds to the sensor electrode 131A directly above the GUI button 401 displaying number 1 detecting the maximum capacitance among the 12 sensor electrodes 131A to 131L directly above the 12 GUI buttons 401. The sensor electrode 131A directly above the GUI button 401 displaying number 1 is positioned in the upper half of the display area 120A in a plan view. As described above, the input content display 402 is moved to the position including the space between the three GUI buttons 401 in the third row and the three GUI buttons 401 in the fourth row. This position does not overlap the sensor electrode 131A directly above the GUI buttons 401 displaying number 1.

As illustrated in FIG. 4B, when the proximate operation is performed, a highlight marker 403 is displayed on the outer periphery of the GUI button 401 displaying number 1. The highlight marker 403 is a display for highlighting the GUI button 401 that is selected by the proximate operation with the fingertip FT. The highlight marker 403 is, for example, a frame-like marker that frames the outer periphery of the GUI button 401 in a noticeable color, such as yellow, orange, or the like.

Although the display area 120A having a rectangular shape is described, the display area 120A may have a shape other than the rectangular shape (e.g., a circular shape, an oval shape, a shape in which a part of a rectangle is cut out, or the like). In such a case, in order to move the input content display 402 to a position not overlapping the sensor electrode 131A directly above the GUI button 401 that receives the proximate operation, when the fingertip FT is closer to the outer periphery on one side of the display area 120A than is the center of the display area 120A, the input content display 402 may be displayed at a position closer to the outer periphery of the display area 120A on the opposite side to the outer periphery on the one side than is the center of the display area 120A. When the fingertip FT is closer to the outer periphery of the display area 120A on the opposite side to the outer periphery on the one side than is the center of the display area 120A, the input content display 402 may be displayed at a position closer to the outer periphery on the one side than is the center of the display area 120A. The position closer to the one side than is the center may be a position in any direction, such as a position closer to an upper side, a right-hand side, a left-hand side, a lower side, or the like than is the center.

As illustrated in FIG. 4C, when the fingertip FT further approaches the operation surface 130A from the state as illustrated in FIG. 4B and reaches the position of the second threshold TH2, drawing of an annular indicator 404 is started in a state in which the input content display 402 is moved to the position including the space between the three GUI buttons 401 in the third row and the three GUI buttons 401 in the fourth row. In the state as illustrated in FIG. 4C, the maximum value of the capacitances detected by the sensor electrodes 131A to 131L is detected by the sensor electrode 131A directly above the GUI button 401 displaying number 1, and the capacitance of the sensor electrode 131 becomes equal to or greater than the second threshold and the hover input is being performed. FIG. 4C omits illustration of the dashed-line oval indicating the position of the fingertip FT in FIG. 4B.

The annular indicator 404 is an annular indicator superimposed and displayed on the GUI button 401 at the center of the selected GUI button 401. The annular indicator 404 indicates an elapsed time (duration) from the start of the hover input or the touch input and the remaining time until the hover input or the touch input is determined. The annular indicator 404 is an indicator that extends annularly clockwise from the direction of 12:00 (uppermost side) in a plan view, while the hover input or the touch input is being performed, and becomes annular when the hover input or the touch input is determined. In FIG. 4C, a ring of the annular indicator 404 is not completed, and the input of number 1 by the hover input is not determined.

When the hover input is continued from the state of FIG. 4C and the ring of the annular indicator 404 is completed as illustrated in FIG. 4D, the input of number 1 by the hover input is determined, and number 1 is displayed on the rightmost side of the input content display 402. In this manner, the input content determined to be input is displayed on the input content display 402. Upon determination of the input, the highlight marker 403 and the annular indicator 404 are not displayed. FIG. 4D omits illustration of the dashed-line oval indicating the position of the fingertip FT in FIG. 4B.

FIG. 4E illustrates a state in which the hover input is performed on the GUI button 401 displaying number 2 in the first row, and number 2 is added to the rightmost side of the input content display 402 upon determination of the input. Because the hover input is performed on the GUI button 401 displaying number 2 in the first row, the input content display 402 is moved to the position including the space between the three GUI buttons 401 in the third row and the three GUI buttons 401 in the fourth row, similar to FIG. 4B and FIG. 4C. The sensor electrode 131B (see FIG. 2) directly above the GUI button 401 displaying number 2 is positioned in the upper half of the display area 120A in a plan view. At this time, the position of the input content display 402 is a position not overlapping the sensor electrode 131B directly above the GUI button 401 displaying number 2. FIG. 4E omits illustration of the highlight marker 403 and the annular indicator 404.

FIG. 4F illustrates a state in which the hover input is performed on the GUI button 401 displaying number 8 in the third row, and number 8 is added to the rightmost side of the input content display 402 upon determination of the input. Because the hover input is performed on the GUI button 401 displaying number 8 in the third row, the input content display 402 is moved to the position including a space between the three GUI buttons 401 in the first row and the three GUI buttons 401 in the second row. The sensor electrode 131H (see FIG. 2) directly above the GUI button 401 displaying number 8 is positioned in the lower half of the display area 120A in a plan view. At this time, the position of the input content display 402 is a position not overlapping the sensor electrode 131H directly above the GUI button 401 displaying number 8. FIG. 4F omits illustration of the highlight marker 403 and the annular indicator 404.

### <Internal Configuration of the Touch Screen 100>

FIG. 5 is a diagram illustrating an internal configuration of the touch screen 100. As illustrated in FIG. 5, the touch screen 100 includes the display device 120, a display driver 122, the position input device 130, a position input device driver 150, and the control device 140. These are disposed in the housing 110 (see FIG. 1), which is omitted in FIG. 5.

The display driver 122 is a drive circuit configured to drive the display device 120 in accordance with an image signal supplied from the control device 140, thereby displaying various display contents on the display device 120.

The position input device driver 150 is an example of the detector. The position input device driver 150 is configured to drive the sensor electrode 131 of the position input device 130 and detect the capacitance in the position input device 130. The position input device driver 150 converts a capacitance value (analog value) of the capacitance detected by the position input device 130 into a count value (digital value) and outputs a capacitance detection signal indicating the count value to the control device 140.

The control device 140 controls the entire touch screen 100. For example, the control device 140 performs, for example, control of display by the display device 120, control of an input operation by the position input device 130, and control of an output of the operation signal to an operation target device. For example, a microcomputer or the like is used as the control device 140.

### <Hardware Configuration of the Control Device 140>

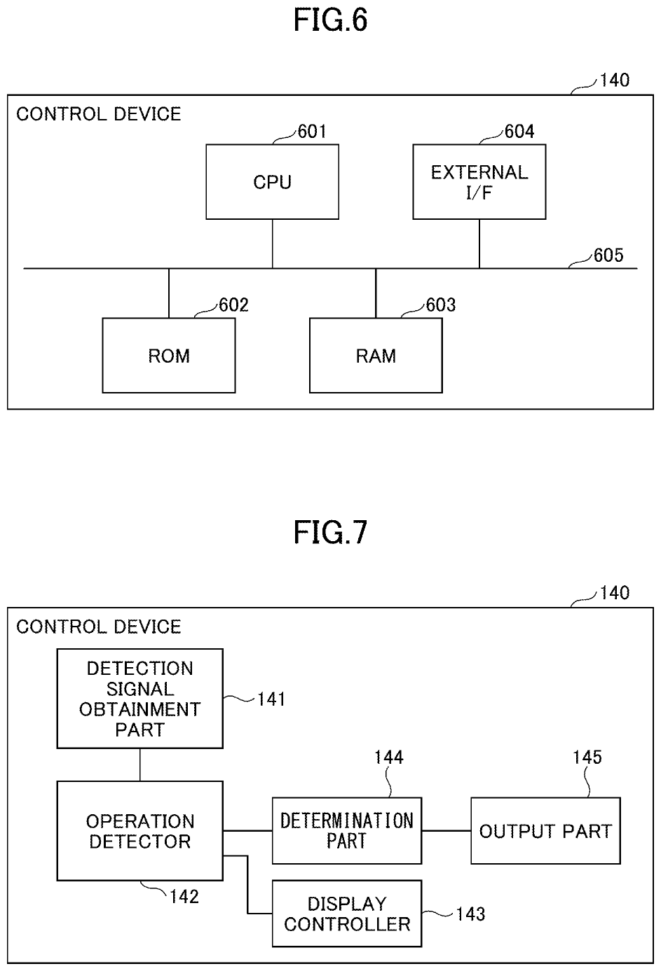

FIG. 6 illustrates a hardware configuration of the control device 140. As illustrated in FIG. 6, the control device 140 includes a central processing unit (CPU) 601, a read only memory (ROM) 602, a random access memory (RAM) 603, and an external interface (I/F) 604. These hardware components are connected to each other via a bus 605.

The CPU 601 executes various programs stored in the ROM 602, thereby controlling the operation of the control device 140. The ROM 602 is a nonvolatile memory. For example, the ROM 602 stores a program executed by the CPU 601, data necessary for the CPU 601 to execute the program, and the like. The RAM 603 is a main storage device, such as a dynamic random access memory (DRAM), a static random access memory (SRAM), or the like. For example, the RAM 603 functions as a work area used by the CPU 601 for executing the program. The external I/F 604 controls input and output of data to and from the exterior (e.g., the position input device driver 150, the display driver 122, the operation target device by the touch screen 100, or the like).

### <Functional Configuration of the Control Device 140>

FIG. 7 illustrates a functional configuration of the control device 140. As illustrated in FIG. 7, the control device 140 includes a detection signal obtainment part 141, an operation detector 142, a display controller 143, a determination part 144, and an output part 145.

The functions of the control device 140 as illustrated in FIG. 7 are realized, for example, by the CPU 601 executing the programs stored in the ROM 602 in the control device 140. The programs may be provided in a state of being introduced into the control device 140 in advance, or may be provided from the exterior and introduced into the control device 140. In the latter case, the programs may be provided by an external storage medium (e.g., a USB memory, a memory card, a CD-ROM, or the like) or may be provided by downloading the programs from a server on a network (e.g., the Internet or the like).

The detection signal obtainment part 141 is configured to obtain the capacitance detection signal output from the position input device driver 150. For example, the position input device driver 150 continuously outputs the capacitance detection signal at predetermined time intervals. In response, the detection signal obtainment part 141 continuously obtains the capacitance detection signal.

The operation detector 142 is configured to detect the operation performed on the operation surface 130A of the position input device 130 based on the capacitance detection signal obtained by the detection signal obtainment part 141 (i.e., the capacitance of the position input device 130). Here, the operation detector 142 can utilize a publicly known technique to distinguishably detect the proximate operation or the hover input performed on the operation surface 130A based on the magnitude of the capacitance, the distribution of the capacitance, and the like in the position input device 130. The operation detector 142 can detect a positional correspondence between the proximate operation or the hover input and the sensor electrodes 131.

As described above, the operation detector 142 can distinguish the proximate operation from the hover input. In addition, the operation detector 142 may distinguish the hover input from the touch input and detect a position at which the touch input is performed. Further, the operation detector 142 may detect approach of the fingertip FT to the operation surface 130A based on the magnitude of the capacitance, the distribution of the capacitance, and the like in the position input device 130.

The display controller 143 is configured to supply an image signal to the display driver 122, and cause the display device 120 to display various display contents, such as the GUI button 401, the input content display 402, the highlight marker 403, the annular indicator 404, and the like. The display controller 143 performs switching control of display as illustrated in FIG. 4A to FIG. 4G.

The determination part 144 is configured to determine the hover input or the touch input when the hover input or the touch input performed on the GUI button 401 continues for a predetermined period of time in the case in which the hover input or the touch input performed on the GUI button 401 displayed on the display device 120 is detected by the operation detector 142. When the hover input or the touch input is determined, selection of the GUI button 401 on which the hover input or the touch input is performed is determined.

When the touch input performed on the GUI button 401 is detected by the operation detector 142, the determination part 144 may immediately determine the selection of the GUI button 401 without awaiting the continuation for the predetermined period of time.

The output part 145 is configured to output a control signal corresponding to the GUI button 401 to the operation target device when the selection of the GUI button 401 is determined by the determination part 144. The output of the control signal by the output part 145 may be via wireless communication or may be via wired communication.

### <Process Executed by the Control Device 140>

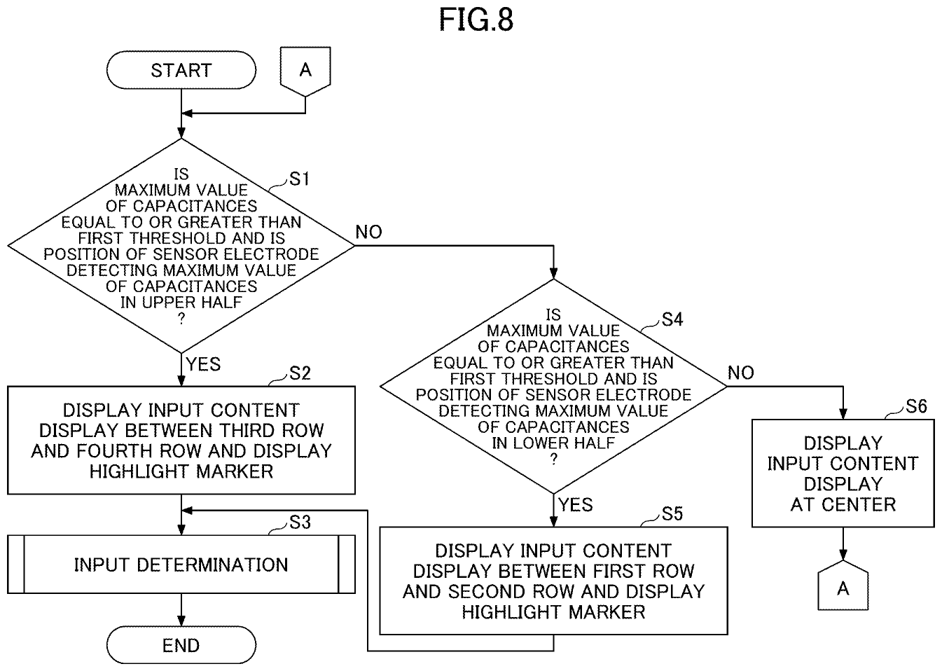

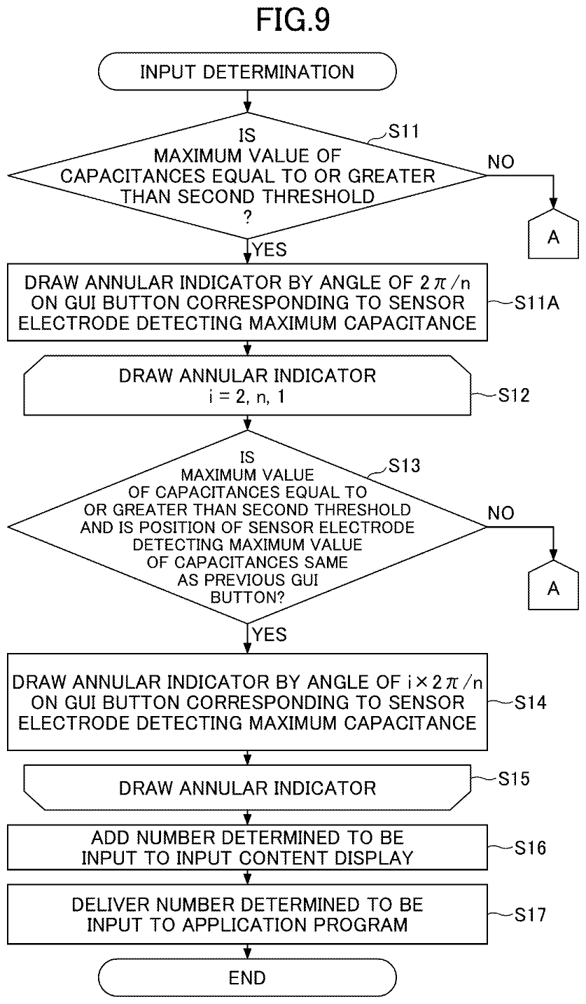

FIG. 8 and FIG. 9 are flowcharts illustrating a process executed by the control device 140. When a main flow as illustrated in FIG. 8 is started, it is a prerequisite that the input content display 402 is displayed between the second row and the third row of the display area 120A of the display device 120, as illustrated in FIG. 4A. The position between the second row and the third row is the position of the center of the display area 120A.

### <Main Flow (FIG. 8)>

When the process is started (START), the operation detector 142 of the control device 140 determines whether or not the maximum value of the capacitances is equal to or greater than the first threshold TH1 and whether or not the position of the sensor electrode 131 detecting the maximum value of the capacitances overlaps the upper half of the display area 120A (step S1).

When the operation detector 142 determines that the maximum value of the capacitances is equal to or greater than the first threshold TH1 and that the position of the sensor electrode 131 detecting the maximum value of the capacitances overlaps the upper half of the display area 120A (S1: Yes), the display controller 143 displays the input content display 402 between the third row and the fourth row and displays the highlight marker 403 on the outer periphery of the GUI button 401 below the sensor electrode 131 detecting the maximum value of the capacitances (step S2). The position between the third row and the fourth row is a position not overlapping the sensor electrode 131 detecting the maximum value of the capacitances.

The control device 140 calls the subroutine “INPUT DETERMINATION” and performs an input determination process of determining a state of an input performed by the user (step S3). The process of step S3 is a subroutine process, and as described with reference to FIG. 4C and FIG. 4D, this is a process of determining the input. Details of the process of the input determination will be described below with reference to FIG. 9.

When the control device 140 completes the process of step S3, the control device 140 ends a series of process steps (END).

When the operation detector 142 of the control device 140 determines in step S1 that the maximum value of the capacitances is equal to or greater than the first threshold TH1 and that the position of the sensor electrode 131 detecting the maximum value of the capacitances does not overlap the upper half of the display area 120A (S1: No), the operation detector 142 determines whether or not the maximum value of the capacitances is equal to or greater than the first threshold TH1 and the position of the sensor electrode 131 detecting the maximum value of the capacitances overlaps the lower half of the display area 120A (step S4).

When the operation detector 142 determines that the maximum value of the capacitances is equal to or greater than the first threshold TH1 and that the position of the sensor electrode 131 detecting the maximum value of the capacitances overlaps the lower half of the display area 120A (S4: Yes), the display controller 143 displays the input content display 402 between the first row and the second row and displays the highlight marker 403 on the outer periphery of the GUI button 401 below the sensor electrode 131 detecting the maximum value of the capacitances (step S5). The position between the first row and the second row is a position not overlapping the sensor electrode 131 detecting the maximum value of the capacitances.

In step S4, when the operation detector 142 determines that the maximum value of the capacitances is equal to or greater than the first threshold TH1 and that the position of the sensor electrode 131 detecting the maximum value of the capacitances does not overlap the lower half of the display area 120A (S4: No), the display controller 143 displays the input content display 402 between the second row and the third row (step S6). The position between the second row and the third row is the position of the center of the display area 120A. When the control device 140 ends the process of step S6, the control device 140 returns the flow to step S1.

When the flow proceeds to step S6, the maximum value of the capacitances of all of the sensor electrodes 131 is less than the first threshold TH1. In this case, the fingertip FT is away from the operation surface 130A of the touch screen 100.

### <Process of Input Determination (FIG. 9)>

When a process of input determination is started, the determination part 144 of the control device 140 determines whether or not the maximum value of the capacitances is equal to or greater than the second threshold TH2 (step S11). That is, the determination part 144 determines whether or not the capacitance of the sensor electrode 131, for which the maximum value of the capacitances was determined as equal to or greater than the first threshold TH1 in step S1 or step S4, is equal to or greater than the second threshold TH2.

When the determination part 144 determines that the maximum value of the capacitances is equal to or greater than the second threshold TH2 (S11: Yes), the display controller 143 draws the annular indicator 404 by an angle of 2π/n (rad) (step S11A). Here, n is the same value as n that is used as a condition for ending the loop process of step S12 to step S15.

Next, the display controller 143 performs the loop process of drawing the annular indicator 404 while increasing the value i from 2 through n in increments of 1 (step S12 to step S15). In S12, i=2, n, 1 means that the value i is increased from 2 through n in increments of 1.

The value n is the number of divisions in drawing the annular indicator 404, and the value i takes a value of from 2 through n. The annular indicator 404 is drawn in steps of 2π/n (rad) around the center of a ring from a non-displayed state by repeating the loop process of step S12 to step S15.

The determination part 144 determines whether or not the maximum value of the capacitances is equal to or greater than the second threshold TH2 and whether or not the GUI button 401 below the sensor electrode 131 detecting the maximum value of the capacitances is the same as the previous one (step S13). That is, when the position of the sensor electrode 131 detecting the maximum value of the capacitances does not change from that in step S11A, the loop process of step S12 to step S15 is repeated.

The display controller 143 draws the annular indicator 404 by an angle of i×2π/n (rad) over the GUI button 401 below the sensor electrode 131 detecting the maximum value of the capacitances (step S14). For example, the annular indicator 404 is drawn clockwise from the uppermost portion of the ring.

In the configuration as described above, the GUI buttons 401 and the sensor electrodes 131 are disposed so as to correspond to each other one by one. However, when a plurality of sensor electrodes 131 are included in the display area of the single GUI button 401, similarly, the determination part 144 may determine in step S13 whether or not the maximum value of the capacitances is equal to or greater than the second threshold TH2 and whether or not the GUI button 401 below the sensor electrode 131 detecting the maximum value of the capacitances is the same as the GUI button 401 in which the annular indicator 404 was drawn previously. In this case, when the GUI button 401 is the same as the previous one, the sensor electrode 131 may be different. For example, in the case in which there are two sensor electrodes 131 in the display area of the single GUI button 401, when in the next cycle following the cycle in which the capacitance of one of the two sensor electrodes 131 reaches the maximum value and is equal to or greater than the second threshold TH2, the capacitance of the other sensor electrode 131 reaches the maximum value and is equal to or greater than the second threshold TH2, the loop process of step S12 to step S15 is repeated, regarding that the GUI button 401 is the same as the previous one.

When the determination part 144 determines that the GUI button 401 below the sensor electrode 131 in which the maximum value of the capacitances is equal to or greater than the second threshold TH2 and that detects the maximum value of the capacitances is the same as the previous one that is the GUI button 401 in which the annular indicator 404 was drawn in the loop process of step S12 to step S15 (S13: Yes), the control device 140 repeats the loop process of step S12 to step S15. When the drawing of the annular indicator 404 is completed by repeating the loop process of step S12 to step S15, the control device 140 switches the annular indicator 404 and the highlight marker 403 to be non-displayed.

When the drawing of the annular indicator 404 is completed by repeating the loop process of step S12 to step S15, the determination part 144 of the control device 140 adds a number determined to be input to the input content display 402 (step S16). The number determined to be input is a number shown by the GUI button 401 displayed below the sensor electrode 131 in which the maximum value of the capacitances is detected. For example, as illustrated in FIG. 4D to FIG. 4G, the numbers are added to the input content display 402.

The control device 140 delivers the number determined to be input to the application program (step S17). As a result, the application program performs a process in accordance with the received number.

The control device 140 returns the flow to step S1 when the determination part 144 does not determine in step S13 that the GUI button 401 below the sensor electrode 131 in which the maximum value of the capacitances is equal to or greater than the second threshold TH2 and that detects the maximum value of the capacitances is the same as the previous one that is the GUI button 401 in which the annular indicator 404 was drawn in the loop process of step S12 to step S15 (S13: No).

As described above, the image of the GUI button 401 representing the input operation area and the image of the input content display 402 representing the input content that is input by operating the GUI button 401 are displayed on the display device 120. In this state, when the capacitance detected by the position input device driver 150 becomes equal to or greater than the first threshold TH1, the image of the input content display 402 is moved to a position not overlapping the sensor electrode 131 detecting the maximum capacitance among the plurality of sensor electrodes 131. Therefore, the already input content can be confirmed in the input content display 402 moved so as not to overlap the fingertip FT.

Therefore, it is possible to provide the touch screen 100 configured to move the image of the input content display 402 representing the input content by the operation performed on the GUI button 401 with the hand or the like so as not to overlap the hand or the like.

When the capacitance detected by the position input device driver 150 becomes equal to or greater than the second threshold TH2, the control device 140 determines the input to the GUI button 401 corresponding to the sensor electrode 131 detecting the maximum capacitance. The second threshold TH2 is greater than the first threshold TH1 and corresponds to the capacitance with which the input is determinable with the fingertip FT not being in contact with the top plate 136. Therefore, it is possible to provide the touch screen 100 capable of reliably determining the input by the non-contact hover input.

When the capacitance detected by the position input device driver 150 is less than the first threshold TH1, the control device 140 displays the input content display 402 at the center of the display device 120. When the capacitance detected by the position input device driver 150 is equal to or greater than the first threshold TH1, and the fingertip FT is closer to the upper side than is the center of the display device 120, the input content display 402 is displayed below the center of the display device 120. When the capacitance detected by the position input device driver 150 is equal to or greater than the first threshold TH1, and the fingertip FT is closer to the lower side than is the center of the display device 120, the input content display 402 is displayed above the center of the display device 120. Therefore, it is possible to provide the touch screen 100 capable of displaying the input content display 402 at a position not hidden by the hand 10.

The control device 140 causes the display device 120 to display the images of the GUI buttons 401 arranged longitudinally and laterally, and also display the image of the input content display 402 at the position including the space between the images of the GUI buttons 401. Therefore, the GUI buttons 401 are not completely hidden by the input content display 402. Thus, it is possible to provide the touch screen 100 that can achieve both display of the input content by the input content display 402 and display of the GUI buttons 401 displayed on the back side (rear side) of the input content display 402.

In addition, the images of the plurality of GUI buttons 401 are displayed on the display device 120 in four rows in the longitudinal direction. When the sensor electrode 131 detecting the maximum capacitance is in the upper half of the display area 120A of the display device 120, the image of the input content display 402 is moved to the position including the space between the images of the GUI buttons 401 in the third row and the images of the GUI buttons 401 in the fourth row. When the sensor electrode 131 detecting the maximum capacitance is in the lower half of the display area 120A of the display device 120, the image of the input content display 402 is moved to the position including the space between the images of the GUI buttons 401 in the first row and the images of the GUI buttons 401 in the second row. Therefore, it is possible to provide the touch screen 100 capable of moving the image of the input content display 402 so as not to overlap the hand 10 or the like in the input screen displayed over the four rows in the longitudinal direction, such as the numeric keypad as illustrated in FIG. 4A to FIG. 4G.

Also, the number of the images of the plurality of GUI buttons 401 is equal to the number of the plurality of sensor electrodes 131, and the sizes thereof in a plan view are equal. Further, the images of the plurality of GUI buttons 401 are displayed on the display device 120 such that the position of the outer periphery of the image of each of the GUI buttons 401 coincides with the position of the outer periphery of each of the sensor electrodes 131. Thus, it is possible to provide the touch screen 100 capable of detecting the input to each of the GUI buttons 401 with high accuracy.

### Embodiment 2

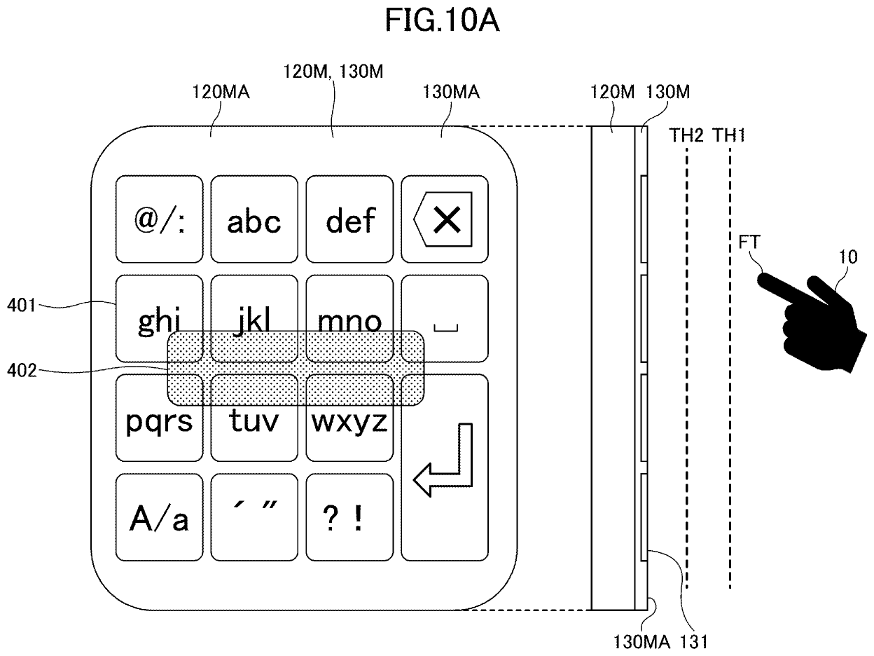

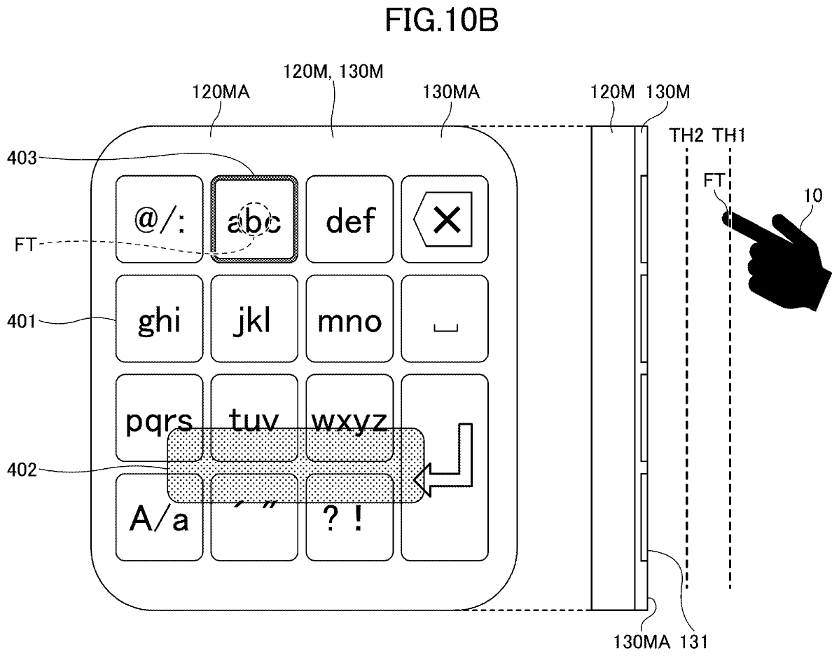

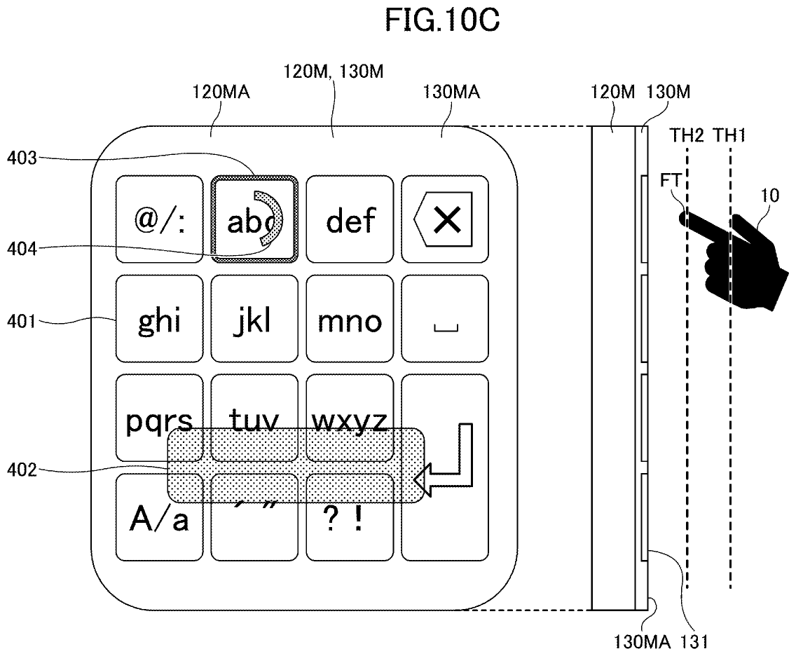

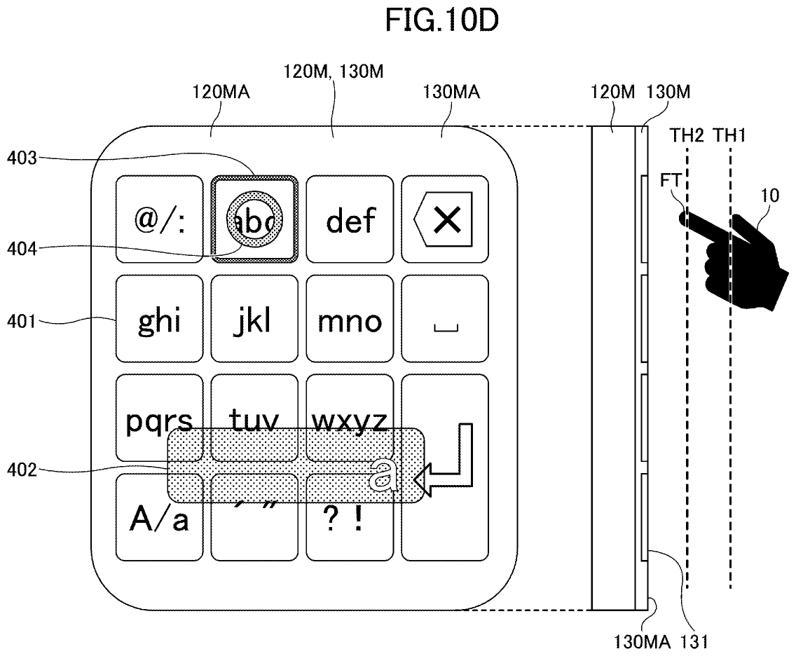

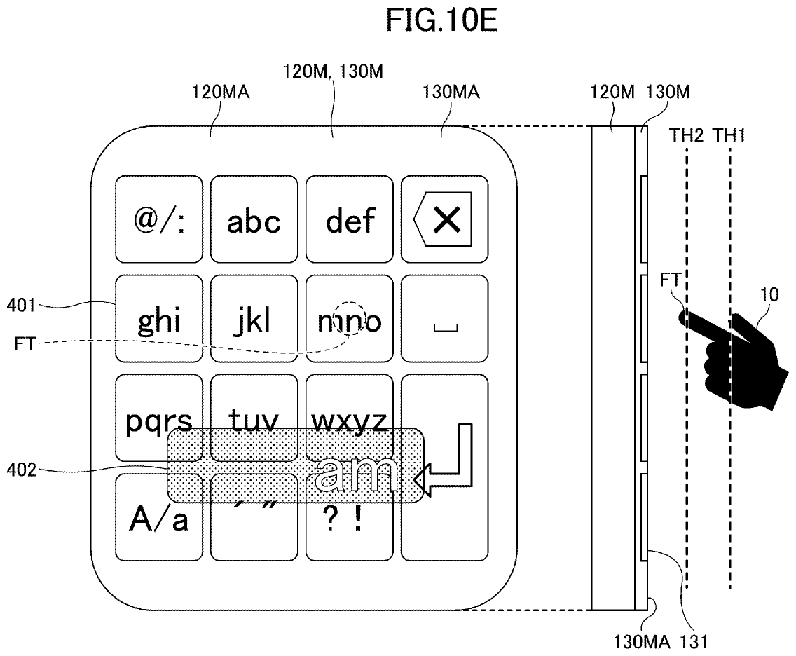

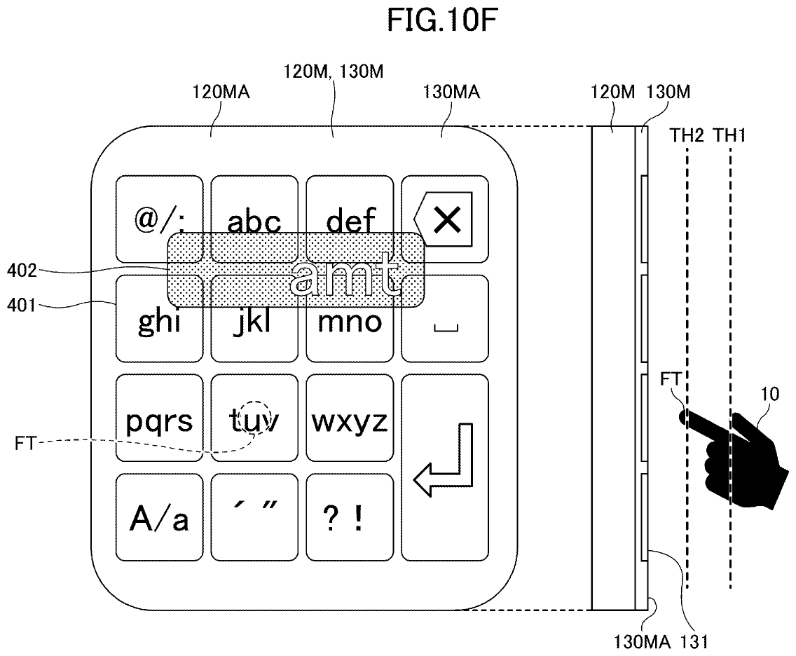

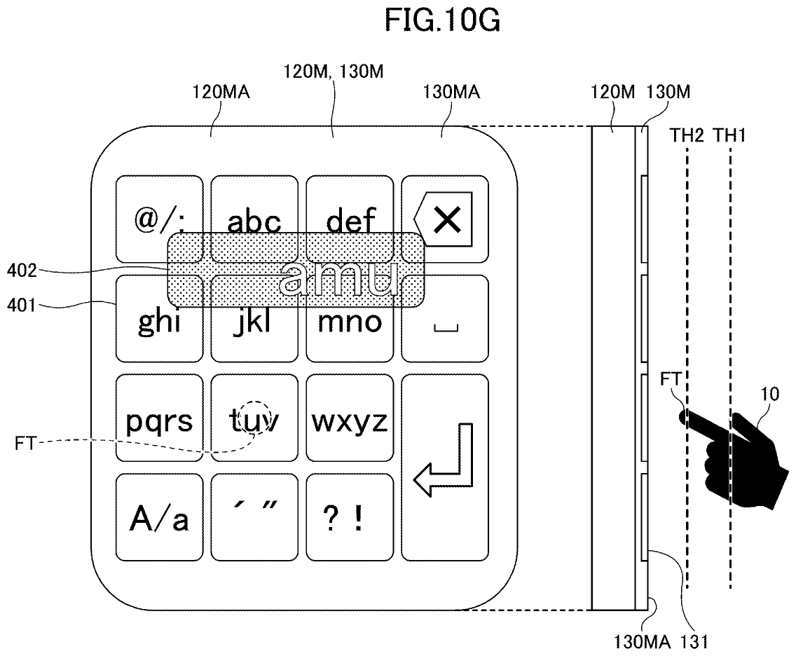

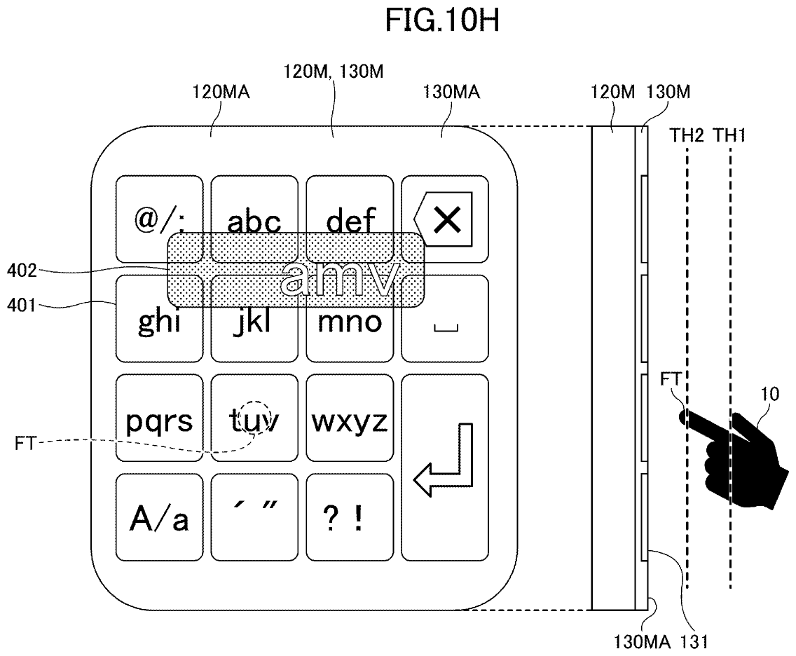

FIG. 10A to FIG. 10H are explanatory diagrams of display by the display device 120M of Embodiment 2. A touch screen of Embodiment 2 has the same configuration as that of the touch screen 100 of Embodiment 1 except that the display device 120 and the position input device 130 of the touch screen 100 of Embodiment 1 are replaced with the display device 120M and a position input device 130M, respectively. The other configurations are the same as those of the touch screen 100 of Embodiment 1, and thus differences will be mainly described below.

The left-hand side of FIG. 10A to FIG. 10H illustrates a state in which the display device 120M, a display area 120MA, the position input device 130M, and an operation surface 130MA are viewed from the upper side thereof. The right-hand side of FIG. 10A to FIG. 10H illustrates cross sections of the display device 120M, the display area 120MA, the position input device 130M, and the operation surface 130MA as viewed from the left-hand side thereof. The sensor electrode 131, the first threshold TH1, the second threshold TH2, and the hand 10 are additionally illustrated in the cross section. The size of the display area 120MA and the size of the operation surface 130MA are approximately the same, and for example, the operation surface 130MA overlaps the entirety of the display area 120MA.

The display device 120M differs from the display device 120 of Embodiment 1 in that the GUI buttons 401 are displayed in the display area 120MA in 4 rows (longitudinal)×4 columns (lateral). Accordingly, the sensor electrodes 131 are arranged in 4 rows (longitudinal)×4 columns (lateral) in the position input device 130M, and the approach detection electrode 132 has a shape that fills spaces between 16 sensor electrodes 131 arranged in 4 rows×4 columns.

As illustrated in FIG. 10A, 15 GUI buttons 401 for inputting of alphabetic letters are displayed in the display area 120MA of the display device 120M of Embodiment 2. The 15 GUI buttons 401 are arranged in a flick input screen on display. In the 15 GUI buttons 401, the GUI button 401 displayed in the first column of the first row is for inputting @, /, or :, the GUI button 401 displayed in the second column of the first row is for inputting a, b, or c, . . . , and the GUI button 401 displayed in the third column of the third row is for inputting w, x, y, or z. The number of the GUI buttons 401 for inputting alphabetic letters a to z is eight.

Further, the GUI buttons 401 displayed in the first to third columns of the fourth row are keys for inputting symbols and the like, such as an A/a key for performing switching between uppercase characters and lowercase characters, an apostrophe (′), a quotation mark (″), and the like. The fourth column displays a backspace key in the first row, a space (blank) key the second row, and an enter key in the third and fourth rows. The size of the GUI button 401 alone of the enter key is about twice the size of the other 14 GUI buttons 401. In this manner, the 15 GUI buttons 401 are arranged and displayed in four rows in the longitudinal direction. The center of the display area 120MA is the center between: the two GUI buttons 401 in the second and third columns of the second row; and the two GUI buttons 401 in the second and third columns of the third row.

The arrangement of the 14 GUI buttons 401 other than the enter key corresponds to the arrangement of the 14 sensor electrodes 131, similar to Embodiment 1. The size of each of the GUI buttons 401 is equal to the size of each of the sensor electrodes 131, and the outer periphery of each of the GUI buttons 401 coincides with the outer periphery of each of the sensor electrodes 131. The GUI button 401 of the enter key corresponds to the two sensor electrodes 131 arranged in the fourth column of the third and fourth rows, among the 16 sensor electrodes 131. The size of the GUI button 401 of the enter key is equal to the size of the two sensor electrodes 131, and the outer periphery of the GUI button 401 of the enter key coincides with the outer periphery of the two sensor electrodes 131.

The 15 GUI buttons 401 are arranged in the flick input screen on display as described above. However, an input method is similar to a toggle input, which will be described below.

### <Description of Operation as Illustrated in FIG. 10A to FIG. 10H>

As illustrated in FIG. 10A, in an initial state in which the fingertip FT does not reach the position of the first threshold TH1, the input content display 402 is displayed at the position including the space between the GUI buttons 401 in the second row and the third row. This is the same as the state as illustrated in FIG. 4A.

As illustrated in FIG. 10B, when the fingertip FT reaches the position of the first threshold TH1 directly above the GUI button 401 in the second column of the first row, the proximate operation is recognized to be performed, and the input content display 402 is moved to a position including a space between the three GUI buttons 401 in the third row and the three GUI buttons 401 in the fourth row. Further, when the proximate operation is performed, the highlight marker 403 is displayed on the outer periphery of the GUI button 401 in the second column of the first row. In FIG. 10B, the position of the fingertip FT is indicated by a dashed-line oval on the GUI button 401 in the second column of the first row. The state as illustrated in FIG. 10B is similar to the state as illustrated in FIG. 4B.

The state in which the fingertip FT reaches the position of the first threshold TH1 directly above the GUI button 401 in the second column of the first row corresponds to the state in which the sensor electrode 131 directly above the GUI button 401 in the second column of the first row detects the maximum value of capacitances. Also, the sensor electrode 131 directly above the GUI button 401 in the second column of the first row is in the upper half of the display area 120MA in a plan view. The position to which the input content display 402 is moved, i.e., the position including the space between the three GUI buttons 401 in the third row and the three GUI buttons 401 in the fourth row, is a position not overlapping the sensor electrode 131 directly above the GUI button 401 in the second column of the first row.

As illustrated in FIG. 10C, when the fingertip FT further approaches the operation surface 130MA from the state as illustrated in FIG. 10B and reaches the position of the second threshold TH2, drawing of the annular indicator 404 is started in a state in which the input content display 402 is moved to the position including the space between the GUI buttons 401 in the third row and the GUI buttons 401 in the fourth row. In the state as illustrated in FIG. 10C, the maximum value of the capacitances detected by all of the sensor electrodes 131 is detected by the sensor electrode 131 directly above the GUI button 401 in the second column of the first row, and the capacitance of the sensor electrode 131 is equal to or greater than the second threshold and the hover input is performed. The state as illustrated in FIG. 10C is similar to the state as illustrated in FIG. 4C. FIG. 10C omits illustration of the dashed-line oval indicating the position of the fingertip FT in FIG. 10B.

When the hover input is continued from the state of FIG. 10C and a ring of the annular indicator 404 is completed as illustrated in FIG. 10D, the input of the letter a is determined and the letter a is displayed on the rightmost side of the input content display 402. In this manner, the input content determined to be input is displayed on the input content display 402. Upon determination of the input, the highlight marker 403 and the annular indicator 404 are not displayed. The state as illustrated in FIG. 10D is similar to the state as illustrated in FIG. 4D. FIG. 10D omits illustration of the dashed-line oval indicating the position of the fingertip FT in FIG. 10B.

FIG. 10E illustrates a state in which the hover input is performed on the GUI button 401 in the third column of the second row, and upon determination of the input, the letter m is added to the rightmost side of the input content display 402. Because the hover input is performed on the GUI button 401 in the third column of the second row, the input content display 402 is moved to the position including the space between the GUI buttons 401 in the third row and the GUI buttons 401 in the fourth row, similar to FIG. 10B and FIG. 10C. The sensor electrode 131 in the third column of the second row, which is directly above the GUI button 401 in the third column of the second row, is in the upper half of the display area 120MA in a plan view. At this time, the position of the input content display 402 is a position not overlapping the sensor electrode 131B in the third column of the second row. FIG. 10E omits illustration of the highlight marker 403 and the annular indicator 404.

FIG. 10F illustrates a state in which the hover input is performed on the GUI button 401 in the second column of the third row, and before determination of the input, the first letter t of the letters t, u, and v included in the display of the GUI button 401 in the second column of the third row is displayed on the rightmost side of the input content display 402. This state is during the course of performing an input similar to a toggle input, and in this state, the input of the letter t is not determined. Because the hover input is performed on the GUI button 401 in the second column of the third row, the input content display 402 is moved to the position including the space between the GUI buttons 401 in the first row and the GUI buttons 401 in the second row. The sensor electrode 131H in the second column of the third row directly above the GUI button 401 in the second column of the third row is in the lower half of the display area 120MA in a plan view. At this time, the position of the input content display 402 is a position not overlapping the sensor electrode 131 in the second column of the third row.

FIG. 10G illustrates a state in which the hover input is continuously performed on the GUI button 401 in the second column of the third row from the state as illustrated in FIG. 10F. When the hover input is continued, the second letter u of the letters t, u, and v included in the display of the GUI button 401 in the second column of the third row is displayed on the rightmost side of the input content display 402.

FIG. 10H illustrates a state in which the hover input is continuously performed on the GUI button 401 in the second column of the third row from the state as illustrated in FIG. 10G. When the hover input is continued, the third letter v of the letters t, u, and v included in the display of the GUI button 401 in the second column of the third row is displayed on the rightmost side of the input content display 402.

In Embodiment 2, as illustrated in FIG. 10F and FIG. 10G, during the course of performing an input similar to the toggle input, when the position of the hover input is changed to a position of another sensor electrode 131 or the hover input is not performed, the input of the character displayed at the end (rightmost) of the GUI button 401 is determined at that time.

### <Process Executed by the Control Device 140>

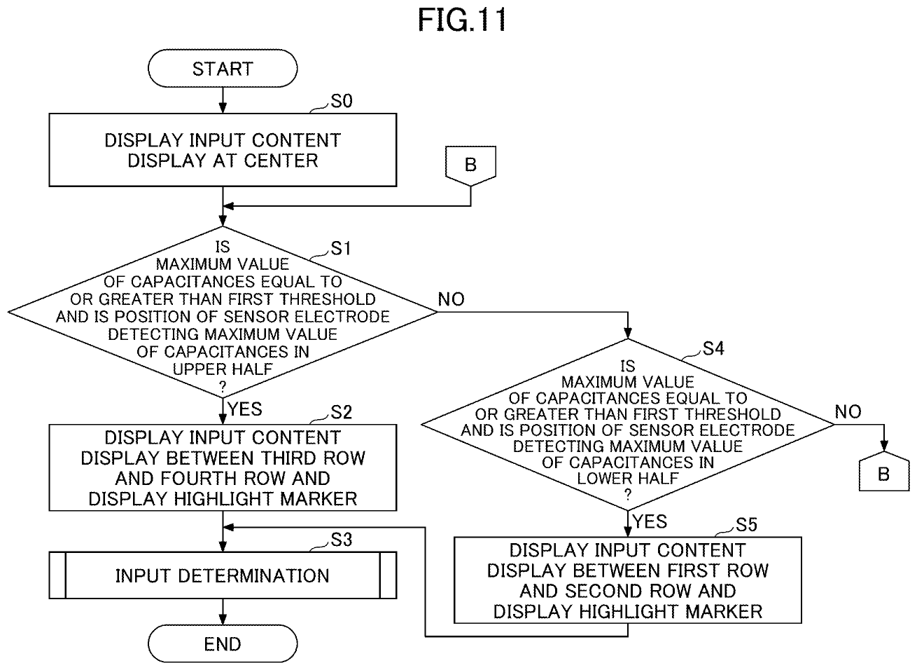

FIG. 11 to FIG. 13 are flowcharts illustrating a process executed by the control device 140 of Embodiment 2. In Embodiment 2, it is assumed that the input content display 402 is not displayed when a main flow as illustrated in FIG. 11 is started.

### <Main Flow (FIG. 11)>

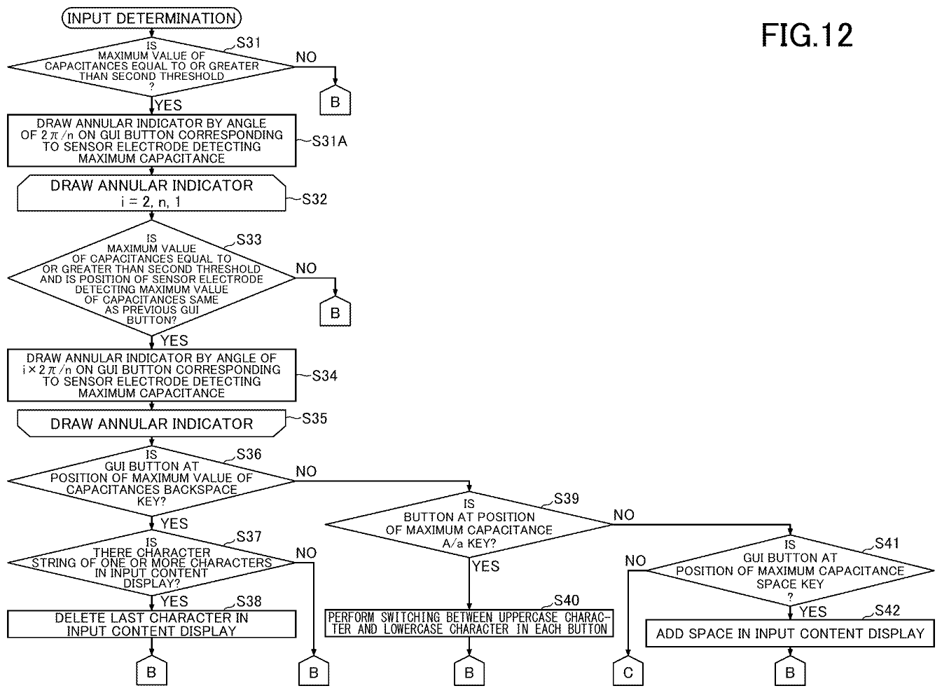

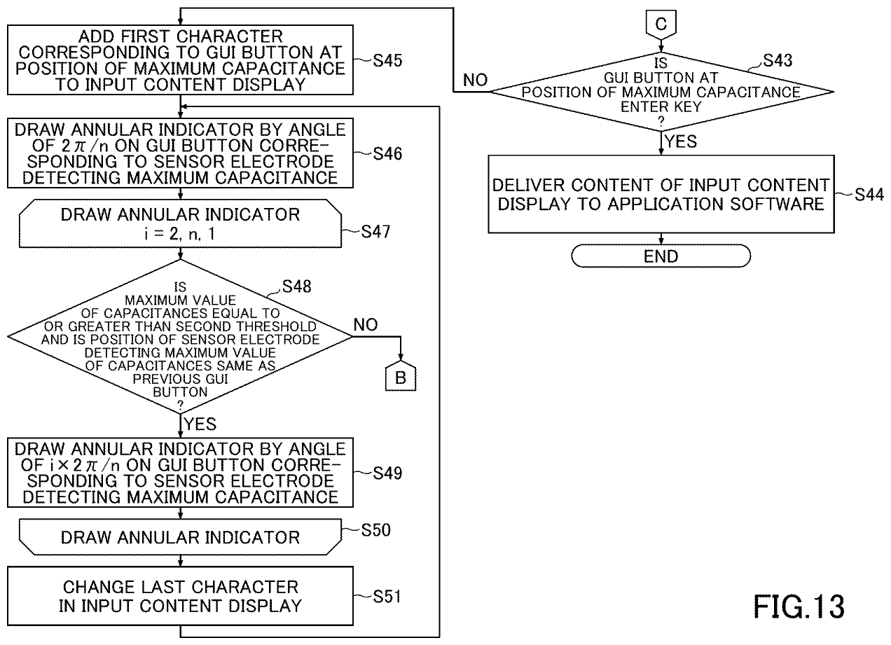

As illustrated in FIG. 10A, the control device 140 displays the input content display 402 between the second row and the third row of the display area 120A of the display device 120 (step S0). When the control device 140 ends the process of step S0, the control device 140 performs the same process as in step S1 to step S5 as illustrated in FIG. 8. Therefore, the description of step S1 to step S5 will be omitted here. The contents of the subroutine “INPUT DETERMINATION” in step S3 will be described below with reference to FIG. 12 and FIG. 13.

### <Process of Input Determination (FIG. 12 and FIG. 13)>

In Embodiment 2, the control device 140 first executes step S31 to step S35 similar to step S11 to step S15 of Embodiment 1.

When a process of input determination is started, the determination part 144 of the control device 140 determines whether or not the maximum value of the capacitances is equal to or greater than the second threshold TH2 (step S31). That is, the determination part 144 determines whether or not the capacitance of the sensor electrode 131, determined in step S1 or step S4 that the maximum value of the capacitances is equal to or greater than the first threshold TH1, is equal to or greater than the second threshold TH2.

When the determination part 144 determines that the maximum value of the capacitances is equal to or greater than the second threshold TH2 (S31: Yes), the control device 140 draws the annular indicator 404 by an angle of 2π/n (rad) on the GUI button corresponding to the sensor electrode detecting the maximum capacitance (step S31A). Subsequently, the control device 140 performs a loop process of drawing the annular indicator 404 while increasing the value i from 2 through n in increments of 1 (step S32 to step S35). In S32, i=2, n, 1 mean that the value i is increased from 2 through n in increments of 1.

The value n is the number of divisions in drawing the annular indicator 404, and the value i takes a value of from 2 through n. The annular indicator 404 is drawn in steps of 2π/n (rad) around the center of a ring from a non-displayed state by repeating the loop process of step S32 to step S35.

The determination part 144 determines whether or not the maximum value of the capacitances is equal to or greater than the second threshold TH2 and whether or not the GUI button 401 below the sensor electrode 131 detecting the maximum value of the capacitances is the same as the previous one (step S33). That is, when the position of the sensor electrode detecting the maximum value of the capacitances does not change from that in step S31A, the loop process of step S32 to step S35 is repeated.

The display controller 143 draws the annular indicator 404 by an angle of i×2π/n (rad) over the GUI button 401 below the sensor electrode 131 detecting the maximum value of the capacitances (step S34). For example, the annular indicator 404 is drawn clockwise from the uppermost portion of the ring.

When the determination part 144 determines that the GUI button 401 below the sensor electrode 131 in which the maximum value of the capacitances is equal to or greater than the second threshold TH2 and that detects the maximum value of the capacitances is the same as the previous one that is the GUI button 401 in which the annular indicator 404 was drawn (S33: Yes), the control device 140 repeats the loop process of step S32 to step S35. When the drawing of the annular indicator 404 is completed by repeating the loop process of step S32 to step S35, the control device 140 switches the annular indicator 404 and the highlight marker 403 to be non-displayed.

The control device 140 returns the flow to step S1 when the determination part 144 does not determine in step S33 that the GUI button 401 below the sensor electrode 131 in which the maximum value of the capacitances is equal to or greater than the second threshold TH2 and that detects the maximum value of the capacitances is the same as the previous one that is the GUI button 401 in which the annular indicator 404 was drawn (S33: No).

When the loop process of step S32 to step S35 is completed, the determination part 144 determines whether or not the GUI button 401 below the sensor electrode 131 detecting the maximum value of the capacitances is a backspace key (step S36).

When the determination part 144 determines that the GUI button 401 below the sensor electrode 131 detecting the maximum value of the capacitances is a backspace key (S36: Yes), the determination part 144 determines whether or not the input content display 402 includes a character string of one or more characters (step S37).

When the determination part 144 determines that the input content display 402 includes a character string of one or more characters (S37: Yes), the determination part 144 deletes the last (rightmost) character displayed on the input content display 402 (step S38). When the control device 140 ends the process of step S38, the control device 140 returns the flow to step S1.

Also, the determination part 144 returns the flow to step S1 when the determination part 144 determines in step S37 that the input content display 402 does not include a character string of one or more characters (S37: No).

When the determination part 144 determines in step S36 that the GUI button 401 below the sensor electrode 131 detecting the maximum value of the capacitances is not a backspace key (S36: No), the determination part 144 determines whether or not the GUI button 401 below the sensor electrode 131 detecting the maximum value of the capacitances is an A/a key for performing switching between uppercase characters and lowercase characters (step S39).

When the determination part 144 determines that the GUI button 401 below the sensor electrode 131 detecting the maximum value of the capacitances is the A/a key for performing switching between uppercase characters and lowercase characters (S39: Yes), the determination part 144 performs switching from letters a to z displayed on the eight GUI buttons 401 for inputting letters a to z, to uppercase letters A to Z (step S40). When the display of the eight GUI buttons is changed, a letter to be input next time is switched between the uppercase character and the lowercase character. When the control device 140 ends the process of step S40, the control device 140 returns the flow to step S1.

When the determination part 144 determines in step S39 that the GUI button 401 below the sensor electrode 131 detecting the maximum value of the capacitances is not the A/a key for performing switching between the uppercase characters and the lowercase characters (S39: No), the determination part 144 determines whether or not the GUI button 401 below the sensor electrode 131 detecting the maximum value of the capacitances is a space key (step S41).

When the determination part 144 determines that the GUI button 401 below the sensor electrode 131 detecting the maximum value of the capacitances is a space key (S41: Yes), the determination part 144 adds one space at the end (rightmost) of the input content display 402 (step S42). When the control device 140 ends the process of step S42, the control device 140 returns the flow to step S1.

When the determination part 144 determines in step S41 that the GUI button 401 below the sensor electrode 131 detecting the maximum value of the capacitances is not a space key (S41: No), the determination part 144 determines whether or not the GUI button 401 below the sensor electrode 131 detecting the maximum value of the capacitances is an enter key (step S43).

When the determination part 144 determines that the GUI button 401 below the sensor electrode 131 detecting the maximum value of the capacitances is an enter key (S43: Yes), the determination part delivers the display contents of the input content display 402 to an application program (step S44). As a result, the application program performs a process in accordance with the received character string. When the control device 140 ends the process of step S44, the control device 140 ends a series of process steps (END).

When the determination part 144 determines in step S43 that the GUI button 401 below the sensor electrode 131 detecting the maximum value of the capacitances is not an enter key (S43: No), the determination part 144 adds the first letter of the letters included in the display of the GUI button 401 below the sensor electrode 131 detecting the maximum value of the capacitances, to the end (rightmost) of the input content display 402 (step S45). The letter displayed in the input content display 402 in step S45 is in a state of being provisionally determined. The provisional determination is a state in which the letter may be determined but may be changed. For example, when the sensor electrode 131 detecting the maximum value of the capacitances is the sensor electrode 131 in the second column of the third row, t of letters t, u, and v displayed on the GUI button 401 in the second column of the third row is displayed at the end (rightmost) of the input content display 402, as illustrated in FIG. 10F.

When the letter in the provisionally determined state is added to the end (rightmost) of the input content display 402, the display controller 143 draws the annular indicator 404 by an angle of 2π/n (rad) over the GUI button 401 below the sensor electrode 131 detecting the maximum value of the capacitances (step S46). Here, n is the same value as n that is used as a condition for ending the loop process of step S47 to step S50.

Next, the control device 140 performs a loop process of drawing the annular indicator 404 while increasing the value i from 2 through n in increments of 1 (step S47 to step S50). In S47, i=2, n, 1 mean that the value i is increased from 2 through n in increments of 1.

The display controller 143 draws the annular indicator 404 by an angle of i×2π/n (rad) over the GUI button 401 below the sensor electrode 131 detecting the maximum value of the capacitances (step S49). For example, the annular indicator 404 is drawn clockwise from the uppermost portion of the ring.

The determination part 144 determines that the GUI button 401 below the sensor electrode 131 in which the maximum value of the capacitances is equal to or greater than the second threshold TH2 and that detects the maximum value of the capacitances is the same as the previous one that is the GUI button 401 in which the annular indicator 404 was drawn (S48: Yes).

When the determination part 144 determines that the GUI button 401 below the sensor electrode 131 in which the maximum value of the capacitances is equal to or greater than the second threshold TH2 and that detects the maximum value of the capacitances is the same as the previous one (S48: Yes), the control device 140 repeats the loop process of step S47 to step S50. That is, when the position of the sensor electrode detecting the maximum value of the capacitances does not change from that in step S31A, the loop process of step S47 to step S50 is repeated. When the drawing of the annular indicator 404 is completed by repeating the loop process of step S47 to step S50, the control device 140 switches the annular indicator 404 to be non-displayed.

When the drawing of the annular indicator 404 is completed by repeating the loop process of step S47 to step S50, the determination part 144 changes the last (rightmost) character of the input content display 402 to the next letter of the selected GUI button 401 (step S51). For example, when the sensor electrode 131 detecting the maximum value of the capacitances is the sensor electrode 131 in the second column of the third row, and the letter t is displayed at the end (rightmost) of the input content display 402 as illustrated in FIG. 10F, the letter u is displayed by the process in step S51 as illustrated in FIG. 10G. When the process in step S51 is completed, the control device 140 returns the flow to step S46. When the flow proceeds to step S51 again, the letter v is displayed at the end (rightmost) of the input content display 402 as illustrated in FIG. 10H.

When the process of step S46 to step S51 is repeated with the hover input being retained, the letter to be displayed at the end (rightmost) of the input content display 402 is changed like in the toggle input.

When the determination part 144 determines in step S48 that the maximum value of the capacitances is equal to or greater than the second threshold TH2 and that the GUI button 401 below the sensor electrode 131 detecting the maximum value of the capacitance is not the same as the previous one that is the GUI button 401 in which the annular indicator 404 was drawn (S48: No), the determination part 144 determines that the character displayed at the end (rightmost) of the input content display 402 is determined at that time, and returns the flow to step S1.

As described above, when the image of the GUI button 401 representing the input operation area and the image of the input content display 402 representing the input content that is input by the operation performed on the GUI button 401 are displayed on the display device 120M, and when the capacitance detected by the position input device driver 150 becomes equal to or greater than the first threshold TH1, the image of the input content display 402 is moved to the position not overlapping the sensor electrode 131 detecting the maximum capacitance of the plurality of sensor electrodes 131. Therefore, even if the fingertip FT overlaps the GUI button 401 being operated and the GUI button 401 displayed below the fingertip FT is not visible, the input content can be confirmed in the input content display 402 moved so as not to overlap the fingertip FT.

Therefore, it is possible to provide the touch screen of Embodiment 2 capable of moving the image of the input content display 402 representing the input content by the operation performed on the GUI button 401 with the hand or the like so as not to overlap the hand or the like.

Although the touch screen of an illustrative embodiment of the present invention has been described above, the present invention is not limited to the specifically disclosed embodiments and can be modified or changed in various ways without departing from the scope of claims.

It is possible to provide the touch screen configured to move the image of the input content display representing the input content that is input by the operation performed on the GUI button with the hand or the like so as not to overlap the hand or the like.

What is claimed is:

1. A touch screen, comprising:
a plurality of sensor electrodes configured to detect an object in proximity to the sensor electrodes in accordance with a capacitance;
a display device provided at a position overlapping the plurality of sensor electrodes;
a detector connected to the plurality of sensor electrodes and configured to detect the capacitance between the plurality of sensor electrodes and the object; and
a controller configured to control an image displayed by the display device based on an output from the detector and determine an input content that is input by the object, wherein
the controller includes
a processor, and
a memory storing one or more programs, which when executed, cause the processor to:
cause the display device to display
an image of a graphic user interface (GUI) button representing an input operation area, and
an image of an input content display representing the input content that is input by an operation performed on the GUI button; and
upon the capacitance detected by the detector being equal to or greater than a first threshold, move the image of the input content display to a position not overlapping the sensor electrode of the plurality of sensor electrodes that detects a maximum capacitance.

2. The touch screen according to claim 1, further comprising:
a cover that can be contacted by the object in proximity to the sensor electrodes, wherein
the one or more programs, when executed, cause the processor to:
use a second threshold greater than the first threshold, the second threshold corresponding to a capacitance at which an input is determinable in a state in which the object is not in contact with the cover; and
upon the capacitance detected by the detector being equal to or greater than the second threshold, determine the input to the GUI button corresponding to the sensor electrode that detects the maximum capacitance.

3. The touch screen according to claim 1, wherein
the one or more programs, when executed, cause the processor to:
upon the capacitance detected by the detector being less than the first threshold, display the input content display at a center of the display device, or
upon the capacitance detected by the detector being equal to or greater than the first threshold and upon the object being closer to an outer periphery on one side of the display device than is the center of the display device, display the input content display at a position closer to the outer periphery of the display device on an opposite side to the outer periphery on the one side than is the center of the display device, or
upon the capacitance detected by the detector being equal to or greater than the first threshold and upon the object being closer to the outer periphery of the display device on the opposite side than is the center of the display device, display the input content display at a position closer to the outer periphery of the display device on the one side than is the center of the display device.

4. The touch screen according to claim 1, wherein
the one or more programs, when executed, cause the processor to:
display images of a plurality of GUI buttons, the images being arranged longitudinally and laterally and each being the image of the GUI button; and
display the input content display at a position including a space between the images of the plurality of GUI buttons.

5. The touch screen according to claim 4, wherein
the one or more programs, when executed, cause the processor to:
cause the display device to display the images of the plurality of GUI buttons, the images being arranged in four or more rows in a longitudinal direction; and
upon the sensor electrode that detects the maximum capacitance being in an upper half of a display area of the display device, move the image of the input content display to a position including a space between two rows of the four or more rows, the two rows being below a center in the longitudinal direction and being next to each other, or
upon the sensor electrode that detects the maximum capacitance being in a lower half of the display area of the display device, move the image of the input content display to a position including a space between two rows of the four or more rows, the two rows being above the center in the longitudinal direction and being next to each other.

6. The touch screen according to claim 5, wherein
the one or more programs, when executed, cause the processor to:
cause the display device to display the images of the plurality of GUI buttons, the images being arranged in four rows in the longitudinal direction; and
upon the sensor electrode that detects the maximum capacitance being in the upper half of the display area of the display device, move the image of the input content display to a position including a space between the images of the GUI buttons in a third row and a fourth row from above in the longitudinal direction, or
upon the sensor electrode that detects the maximum capacitance being in the lower half of the display area of the display device, move the image of the input content display to a position including a space between the images of the GUI buttons in a first row and a second row from above in the longitudinal direction.

7. The touch screen according to claim 6, wherein
the images of the plurality of GUI buttons and the plurality of sensor electrodes are equal in number and size in a plan view, and
the one or more programs, when executed, cause the processor to:
cause the display device to display the images of the plurality of GUI buttons such that a position of an outer periphery of each of the images of the GUI buttons coincides with a position of an outer periphery of a corresponding sensor electrode of the sensor electrodes.
